(19) United States
(12) Patent Application Publication
(10) Pub. No.: US 2025/0267397 A1
(43) Pub. Date: Aug. 21, 2025

(54) SOUND APPARATUS

(71) Applicant: LG Display Co., Ltd., Seoul (KR)

(72) Inventors: Seungo Jeon, Paju-si (KR); Daeduk Kim, Paju-si (KR); DaeHwan Park, Paju-si (KR); Yongjoon Kim, Paju-si (KR); Jaewon Hwang, Paju-si (KR)

(73) Assignee: LG Display Co., Ltd., Seoul (KR)

(21) Appl. No.: 19/051,801

(22) Filed: Feb. 12, 2025

(30) Foreign Application Priority Data
Feb. 19, 2024 (KR) 10-2024-0023830

(51) Int. Cl. H04R 1/34; H04R 1/02; H04R 1/06; H04R 7/04; H04R 17/00

(52) U.S. Cl. CPC H04R 1/345; H04R 1/025; H04R 1/028; H04R 1/06; H04R 7/04; H04R 17/00

(57) ABSTRACT

One or more embodiments of the present disclosure provides a sound apparatus which comprises a sound output module having an opening portion, a support structure provided in the sound output module, and a guide member provided in the support structure and disposed below the opening portion. The sound apparatus according to one or more embodiments of the present disclosure can output sound in multiple directions, and the structure can be simplified.

### CROSS-REFERENCE TO RELATED APPLICATIONS

This application claims the benefit of the Korean Patent Application No. 10-2024-0023830 filed on Feb. 19, 2024, which is hereby incorporated by reference as if fully set forth herein.

### BACKGROUND

### Technical Field

The present disclosure relates to an apparatus capable of outputting sound.

### Description of the Related Art

In recent years, there has been growing interest in integrating sound output functionality into various devices, including lighting apparatuses. Traditional sound output devices, such as standalone speakers or sound modules, typically emit sound in a single direction, resulting in a limited sound output range.

### BRIEF SUMMARY

The inventors of the present disclosure have recognized that sound emitted from a sound output module is typically unidirectional resulting in a narrow sound output range or transmission range. To address this limitation, conventional lighting apparatuses incorporate multiple sound output modules oriented in various directions to achieve multi-directional sound coverage. However, this approach complicates the structure of the lighting apparatus. Accordingly, various embodiments of the present disclosure aim to provide an improved apparatus capable of delivering sound in multiple directions while simplifying the overall design.

Additional features and advantages of the disclosure will be set forth in the description which follows and in part will be apparent from the description, or may be learned by practice of the disclosure. Other advantages of the present disclosure will be realized and attained by the structure particularly pointed out in the written description and claims hereof as well as the appended drawings.

To achieve these and other advantages, in accordance with the embodiment of the present disclosure, as embodied and broadly described herein, in one or more embodiments, a sound apparatus comprises a sound output module having an opening portion, a support structure provided in the sound output module, and a guide member provided in the support structure and disposed below the opening portion.

According to an embodiment of the present disclosure, the sound apparatus can output sound in multiple directions, and the structure can be simplified.

According to an embodiment of the present disclosure, since the sound apparatus can output sound in multiple directions using a single sound output module, the volume and weight can be reduced, and a lightweight sound apparatus can be implemented.

Other systems, methods, features and advantages will be, or will become, apparent to one with skill in the art upon examination of the following figures and detailed description. It is intended that all such additional systems, methods, features and advantages be included within this description, be within the scope of the present disclosure, and be protected by the following claims. Nothing in this section should be taken as a limitation on those claims. Further aspects and advantages are discussed below in conjunction with aspects of the disclosure.

It is to be understood that both the foregoing description and the following description of the present disclosure are exemplary and explanatory and are intended to provide further explanation of the disclosure as claimed.

### BRIEF DESCRIPTION OF THE SEVERAL VIEWS OF THE DRAWINGS

The accompanying drawings, which are included to provide a further understanding of the disclosure and are incorporated in and constitute a part of this disclosure, illustrate aspects and embodiments of the disclosure and together with the description serve to explain principles of the disclosure.

FIG. 1 is a perspective view illustrating an apparatus according to an aspect of the present disclosure.

FIG. 2 is an exploded perspective view illustrating a sound output module and a guide member shown in FIG. 1 according to an aspect of the present disclosure.

FIG. 3 is a cross-sectional view illustrating a sound output module and a guide member shown in FIG. 1 according to an aspect of the present disclosure.

FIG. 4 is a diagram illustrating a sound output direction and a lighting apparatus according to an aspect of the present disclosure.

FIG. 5 is a cross-sectional view illustrating a sound output module and a guide member shown in FIG. 1 according to another aspect of the present disclosure.

FIG. 6 is a cross-sectional view illustrating a sound output module and a guide member shown in FIG. 1 according to another aspect of the present disclosure.

FIG. 7 is a diagram illustrating a vibration apparatus according to an aspect of the present disclosure.

FIG. 8 is a cross-sectional view taken along line I-I′ of FIG. 7 according to an aspect of the present disclosure.

FIG. 9 is a cross-sectional view taken along line II-II′ of FIG. 7 according to an aspect of the present disclosure.

FIG. 10 is a diagram illustrating a vibration portion according to another aspect of the present disclosure.

FIG. 11 is a diagram illustrating a vibration portion according to another aspect of the present disclosure.

FIG. 12 is a diagram illustrating a vibration apparatus according to another aspect of the present disclosure.

FIG. 13 is a graph illustrating sound pressure characteristics for each frequency of a sound output module according to an aspect of the present disclosure.

FIG. 14 is a graph illustrating sound pressure characteristics for each frequency of an apparatus according to an aspect of the present disclosure.

FIG. 15 is a graph illustrating sound pressure characteristics according to a sound pressure measurement angle of an apparatus according to an aspect of the present disclosure.

FIG. 16 is a diagram illustrating distribution of sound components in a vertical direction of an apparatus according to an aspect of the present disclosure.

FIG. 17 is a diagram illustrating distribution of sound components in a horizontal direction of an apparatus according to an aspect of the present disclosure.

### DETAILED DESCRIPTION

Reference is now made in detail to aspects of the present disclosure, examples of which can be illustrated in the accompanying drawings. In the following description, when a detailed description of well-known functions, structures or configurations can unnecessarily obscure aspects of the present disclosure, a detailed description of such known functions or configurations can have been omitted for brevity. Further, repetitive descriptions can be omitted for brevity. The progression of processing steps and/or operations described is a non-limiting example.

The sequence of steps and/or operations is not limited to that set forth herein and can be changed to occur in an order that is different from an order described herein, with the exception of steps and/or operations necessarily occurring in a particular order. In one or more examples, two operations in succession can be performed substantially concurrently, or the two operations can be performed in a reverse order or in a different order depending on a function or operation involved.

Unless stated otherwise, like reference numerals can refer to like elements throughout even when they are shown in different drawings. In one or more aspects, identical elements (or elements with identical names) in different drawings can have the same or substantially the same functions and properties unless stated otherwise. Names of the respective elements used in the following explanations are selected only for convenience and can be thus different from those used in actual products.

Advantages and features of the present disclosure, and implementation methods thereof, are clarified through the aspects described with reference to the accompanying drawings. The present disclosure may, however, be embodied in different forms and should not be construed as limited to the example aspects set forth herein. Rather, these example aspects are examples and are provided so that this disclosure can be thorough and complete to assist those skilled in the art to understand the inventive concepts without limiting the protected scope of the present disclosure.

Shapes (e.g., sizes, lengths, widths, heights, thicknesses, locations, radii, diameters, and areas), dimensions, ratios, angles, numbers, and the like disclosed herein, including those illustrated in the drawings, are merely examples, and thus, the present disclosure is not limited to the illustrated details. Any implementation described herein as an “example” is not necessarily to be construed as preferred or advantageous over other implementations. It is, however, noted that the relative dimensions of the components illustrated in the drawings are part of the present disclosure.

Where a term like “comprise,” “have,” “include,” “contain,” “constitute,” or the like is used with respect to one or more elements, one or more other elements can be added unless a term such as “only” or the like is used. The terms used in the present disclosure are merely used in order to describe example aspects, and are not intended to limit the scope of the present disclosure. The terms of a singular form can include plural forms unless the context clearly indicates otherwise.

The word “exemplary” is used to mean serving as an example or illustration, unless otherwise specified. Aspects are example aspects. “Embodiments,” “examples,” “aspects,” and the like should not be construed as preferred or advantageous over other implementations. An embodiment, an example, an example aspect, an aspect, or the like can refer to one or more aspects, one or more examples, one or more example embodiments, one or more embodiments, or the like, unless stated otherwise. Further, the term “may” encompasses all the meanings of the term “can.”

In one or more aspects, unless explicitly stated otherwise, element, feature, or corresponding information (e.g., a level, range, dimension, size, or the like) is construed to include an error or tolerance range even where no explicit description of such an error or tolerance range is provided. An error or tolerance range can be caused by various factors (e.g., process factors, internal or external impact, noise, or the like). In interpreting a numerical value, the value is interpreted as including an error range unless explicitly stated otherwise.

In describing a positional relationship, when the positional relationship between two parts (e.g., layers, films, regions, components, sections, or the like) is described, for example, using “on,” “upon,” “on top of,” “over,” “under,” “above,” “below,” “beneath,” “near,” “close to,” “adjacent to,” “beside,” “next to,” “at or on a side of,” or the like, one or more other parts can be located between the two parts unless a more limiting term, such as “immediate(ly),” “direct(ly),” or “close(ly),” is used. For example, where a structure is described as being positioned “on,” “upon,” “on top of,” “over,” “under,” “above,” “below,” “beneath,” “near,” “close to,” “adjacent to,” “beside,” “next to,” “at or on a side of,” or the like another structure, this description should be construed as including a case in which the structures contact each other as well as a case in which one or more additional structures are disposed or interposed therebetween. Furthermore, the terms “front,” “rear,” “back,” “left,” “right,” “top,” “bottom,” “downward,” “upward,” “upper,” “lower,” “up,” “down,” “column,” “row,” “vertical,” “horizontal,” and the like refer to an arbitrary frame of reference.

Spatially relative terms, such as “below,” “beneath,” “lower,” “on,” “above,” “upper” and the like, can be used to describe a correlation between various elements (e.g., layers, films, regions, components, sections, or the like) as shown in the drawings. The spatially relative terms are to be understood as terms including different orientations of the elements in use or in operation in addition to the orientation depicted in the drawings. For example, if the elements shown in the drawings are turned over, elements described as “below” or “beneath” other elements would be oriented “above” other elements. Thus, the term “below,” which is an example term, can include all directions of “above” and “below.” Likewise, an exemplary term “above” or “on” can include both directions of “above” and “below.”

In describing a temporal relationship, when the temporal order is described as, for example, “after,” “subsequent,” “next,” “before,” “preceding,” “prior to,” or the like, a case that is not consecutive or not sequential can be included and thus one or more other events can occur therebetween, unless a more limiting term, such as “just,” “immediate(ly),” or “direct(ly),” is used.

The terms, such as “below,” “lower,” “above,” “upper” and the like, can be used herein to describe a relationship between element(s) as illustrated in the drawings. It will be understood that the terms are spatially relative and based on the orientation depicted in the drawings.

It is understood that, although the terms “first,” “second,” or the like can be used herein to describe various elements (e.g., layers, films, regions, components, sections, or the like), these elements should not be limited by these terms, for example, to any particular order, precedence, or number of elements. These terms are used only to distinguish one element from another. For example, a first element could be termed a second element, and, similarly, a second element could be termed a first element, without departing from the scope of the present disclosure. Furthermore, the first element, the second element, and the like can be arbitrarily named according to the convenience of those skilled in the art without departing from the scope of the present disclosure. For clarity, the functions or structures of these elements (e.g., the first element, the second element and the like) are not limited by ordinal numbers or the names in front of the elements. Further, a first element can include one or more first elements. Similarly, a second element or the like can include one or more second elements or the like.

In describing elements of the present disclosure, the terms “first,” “second,” “A,” “B,” “(a),” “(b),” or the like can be used. These terms are intended to identify the corresponding element(s) from the other element(s), and these are not used to define the essence, basis, order, or number of the elements.

For the expression that an element (e.g., layer, film, region, component, section, or the like) is described as “connected,” “coupled,” “attached,” “adhered,” or the like to another element, the element can not only be directly connected, coupled, attached, adhered, or the like to another element, but also be indirectly connected, coupled, attached, adhered, or the like to another element with one or more intervening elements disposed or interposed between the elements, unless otherwise specified.

For the expression that an element (e.g., layer, film, region, component, section, or the like) “overlaps,” or the like with another element, the element can not only directly contact, overlap, or the like with another element, but also indirectly overlap, or the like with another element with one or more intervening elements disposed or interposed between the elements, unless otherwise specified.

The phrase that an element (e.g., layer, film, region, component, section, or the like) is “provided in,” “disposed in,” or the like in another element can be understood as that at least a portion of the element is provided in, disposed in, or the like in another element, or that the entirety of the element is provided in, disposed in, or the like in another element. The phrase that an element (e.g., layer, film, region, component, section, or the like) “contacts,” “overlaps,” or the like with another element can be understood as that at least a portion of the element contacts, overlaps, or the like with a least a portion of another element, that the entirety of the element contacts, overlaps, or the like with a least a portion of another element, or that at least a portion of the element contacts, overlaps, or the like with the entirety of another element.

The terms such as a “line” or “direction” should not be interpreted only based on a geometrical relationship in which the respective lines or directions are parallel or perpendicular to each other. Such terms can mean a wider range of lines or directions within which the components of the present disclosure can operate functionally. For example, the terms “first direction,” “second direction,” and the like, such as a direction parallel or perpendicular to “X-axis,” “Y-axis,” or “Z-axis,” should not be interpreted only based on a geometrical relationship in which the respective directions are parallel or perpendicular to each other, and can be meant as directions having wider directivities within the range within which the components of the present disclosure can operate functionally.

The term “at least one” should be understood as including any and all combinations of one or more of the associated listed items. For example, each of the phrases of “at least one of a first item, a second item, or a third item” and “at least one of a first item, a second item, and a third item”, can represent (i) a combination of items provided by two or more of the first item, the second item, and the third item or (ii) only one of the first item, the second item, or the third item.

The expression of a first element, a second elements, “and/or” a third element should be understood to encompass one of the first, second, and third elements, as well as any and all combinations of the first, second and third elements. By way of example, A, B and/or C encompass only A; only B; only C; any of A, B, and C (e.g., A, B, or C); some combinations of A, B, and C (e.g., A and B; A and C; or B and C); and all of A, B, and C. Furthermore, an expression “A/B” can be understood as A and/or B. For example, an expression “A/B” can refer to only A; only B; A or B; or A and B.

In one or more aspects, the terms “between” and “among” can be used interchangeably simply for convenience unless stated otherwise. For example, an expression “between a plurality of elements” can be understood as among a plurality of elements. In another example, an expression “among a plurality of elements” can be understood as between a plurality of elements. In one or more examples, the number of elements can be two. In one or more examples, the number of elements can be more than two. Furthermore, when an element (e.g., layer, film, region, component, sections, or the like) is referred to as being “between” at least two elements, the element can be the only element between the at least two elements, or one or more intervening elements can also be present.

In one or more aspects, the phrases “each other” and “one another” can be used interchangeably simply for convenience unless stated otherwise. For example, an expression “different from each other” can be understood as different from one another. In another example, an expression “different from one another” can be understood as different from each other. In one or more examples, the number of elements involved in the foregoing expression can be two. In one or more examples, the number of elements involved in the foregoing expression can be more than two.

In one or more aspects, the phrases “one or more among” and “one or more of” can be used interchangeably simply for convenience unless stated otherwise.

The term “or” means “inclusive or” rather than “exclusive or.” For example, unless otherwise stated or clear from the context, the expression that “x uses a or b” means any one of natural inclusive permutations. For example, “a or b” can mean “a,” “b,” or “a and b.” For example, “a, b or c” can mean “a,” “b,” “c,” “a and b,” “b and c,” “a and c,” or “a, b and c.”

Features of various aspects of the present disclosure can be partially or entirely coupled to or combined with each other, can be technically associated with each other, and can be operated, linked, or driven together in various ways. Aspects of the present disclosure can be implemented or carried out independently from each other, or can be implemented or carried out together in a co-dependent or related relationship. In one or more aspects, the components of each apparatus according to various aspects of the present disclosure can be operatively coupled and configured.

Unless otherwise defined, the terms (including technical and scientific terms) used herein have the same meaning as commonly understood by one of ordinary skill in the art to which example aspects belong. It should be further understood that terms, such as those defined in commonly used dictionaries, should be interpreted as having a meaning, for example, consistent with their meaning in the context of the relevant art and should not be interpreted in an idealized or overly formal sense, unless expressly defined otherwise herein.

The terms used herein have been selected as being general in the related technical field; however, there can be other terms depending on the development and/or change of technology, convention, preference of technicians, and so on. Therefore, the terms used herein should not be understood as limiting technical ideas, but should be understood as examples of the terms for describing example aspects.

Further, in a specific case, a term can be arbitrarily selected by an applicant, and in this case, the detailed meaning thereof is described herein. Therefore, the terms used herein should be understood based on not only the name of the terms, but also the meaning of the terms and the content hereof.

“X-axis direction”, “Y-axis direction” and “Z-axis direction” should not be construed by a geometric relation only of a mutual vertical relation and can have broader directionality within the range that elements of the present disclosure can act functionally.

In the following description, various example aspects of the present disclosure are described in detail with reference to the accompanying drawings. With respect to reference numerals to elements of each of the drawings, the same elements can be illustrated in other drawings, and like reference numerals can refer to like elements unless stated otherwise. The same or similar elements can be denoted by the same reference numerals even though they are depicted in different drawings.

In addition, for convenience of description, a scale, dimension, size, and thickness of each of the elements illustrated in the accompanying drawings can be different from an actual scale, dimension, size, and thickness, and thus, aspects of the present disclosure are not limited to a scale, dimension, size, and thickness illustrated in the drawings.

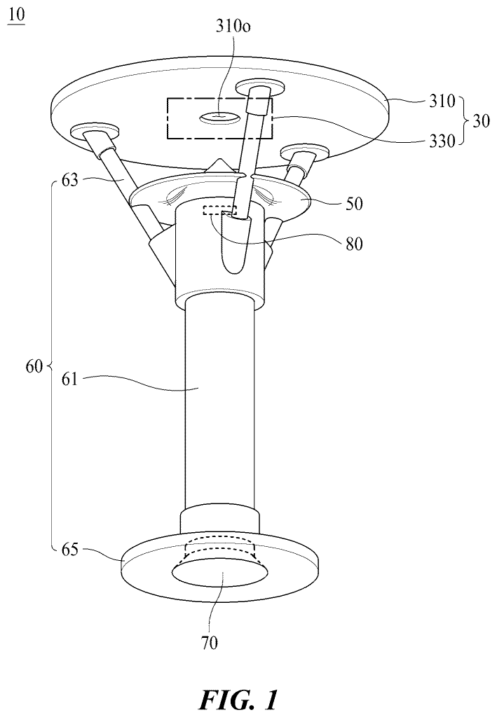

FIG. 1 is a perspective view illustrating an apparatus according to an aspect of the present disclosure.

Referring to FIG. 1, an apparatus 10 according to an aspect of the present disclosure may be a sound apparatus or a lighting apparatus. The apparatus 10 according to an aspect of the present disclosure may include a sound output structure 30 (also referred to as “a sound output module 30”), a guide member 50, a lighting module 80 (also referred to as “a lighting module 80”), a support structure 60, and a low-pitched sound generating structure 70 (also referred to as “a low-pitched sound generating module 70”).

The sound output module 30 may be disposed or mounted at the uppermost end of the support structure 60. The sound output module 30 may be supported by a support portion 63 of the support structure 60. The sound output module 30 may output sound or vibration to the guide member 50. The sound output module 30 may be a sound module, a sound output apparatus, a vibration apparatus, a vibration generating apparatus, a sound system, a sound output module for an electronic apparatus, a sound output module for a display apparatus, or a sound output module for a transportation apparatus. For example, depending on a shape of an enclosure 310, the sound output module 30 may have various shapes such as a circular shape, an oval shape, a quadrangle shape, a rectangular shape, a square shape, and a polygonal shape.

The sound output module 30 according to an aspect of the present disclosure may have an opening portion 3100 (or simply “an opening 3100”). The sound output module 30 may include the opening portion 3100 formed on a surface facing the guide member 50. The sound output module 30 may include the enclosure 310 and a sound generating module 330.

The enclosure 310 may be in the sound generating module 330. The enclosure 310 may support the sound generating module 330 configured therein. The support structure 60 may be configured on a rear surface of the enclosure 310. The enclosure 310 may have an inner space and an opening portion 3100. The sound generating module 330 may be configured in the inner space.

The opening portion 3100 may output sound and vibration generated by the sound generating module 330 to the outside of the sound output module 30 or the enclosure 310. The sound generating module 330 may be provided inside the enclosure 310 and may be configured to generate vibration. The sound generating module 330 may output sound (or sound wave) to the outside of the sound output module 30 or the enclosure 310 through the opening portion 3100 of the enclosure 310. The sound generating module 330 may output sound (or sound wave) in the direction toward the guide member 50 through the opening portion 3100 of the enclosure 310. For example, the sound (or sound wave) generated by the sound generating module 330 is diffused by the guide member 50 and may be output in various directions or 360° directions in the view from the top of the apparatus 10.

According to an aspect of the present disclosure, in the sound output module 30, the enclosure 310 may reflect light input from the lighting module 80 in various directions. For example, the enclosure 310 may reflect light input from the lighting module 80 through the guide member 50 to the lower portion and/or the side surface. For example, light input from the lighting module 80 may be reflected by the lower surface of the enclosure 310 and then diffused in the direction toward the lower and/or lateral part of the sound output module 30. For example, when the light input from the lighting module 80 is viewed from the front of the apparatus 10, the enclosure 310 may diffuse the light in the direction toward the lower and/or lateral part of the sound output module 30 and the guide member 50. For example, when the light input from the lighting module 80 is viewed from the upward direction of the apparatus 10, the enclosure 310 may diffuse the light in various directions or 360° directions. For example, the lighting module 80 or the lighting apparatus may be an organic light emitting lighting apparatus or inorganic light emitting lighting apparatus, but aspects of the present disclosure are not limited thereto.

The guide member 50 may be configured in the support structure 60. The guide member 50 may be provided below the sound output module 30. The guide member 50 may be configured between the sound output module 30 and the lighting module 80. The guide member 50 may be configured under the opening portion 3100 of the sound output module 30. The guide member 50 may guide light emitted by the lighting module 80 toward the sound output module 30. For example, the light output from the lighting module 80 may be guided by the guide member 50, may be output in the direction toward the sound output module 30, reflected by the sound output module 30, and spread toward the lower part of the sound output module 30.

According to an aspect of the present disclosure, the guide member 50 may diffuse the vibration output from the sound output module 30 in various directions. For example, the guide member 50 may diffuse the vibration output from the sound generating module 330 in various directions. For example, the sound (or sound wave) generated by the sound generating module 330 may be output through the opening portion 3100 and may be diffused by the guide member 50. For example, the sound (or sound wave) output from the sound output module 30 may be output in various directions or 360° directions in the view from the top of the apparatus 10.

The support structure 60 may mount sound output module 30 and the guide member 50 thereon. The support structure 60 may be provided in the sound output module 30. The support structure 60 may support the sound output module 30 and the guide member 50. The sound output module 30 may be disposed or mounted at the uppermost end of the support structure 60. The guide member 50 may be disposed or mounted below the sound output module 30 while being spaced apart from the sound output module 30 by a predetermined distance.

The support structure 60 may include a body portion 61, a plurality of support portions 63, and a lower end portion 65.

The body portion 61 may be a cylindrical column, but aspects of the present disclosure are not limited thereto. The body portion 61 may connect the plurality of support portions 63 to the lower end portion 65. The plurality of support portions 63 may be at least two or more, but aspects of the present disclosure are not limited thereto. The plurality of support portions 63 may support the sound output module 30 and the guide member 50. The plurality of support portions 63 may be connected to the lower portion of the sound output module 30 and may be configured to support the lower portion of the sound output module 30. The guide member 50 may be spaced apart from the sound output module 30 and may be supported by the plurality of support portions 63 or disposed between the plurality of support portions 63 while being overlapped with the opening portion 3100. The guide member 50 may be supported by the plurality of support portions 63 while being adjacent to the lighting module 80. The lower end portion 65 may be configured in the lower portion of the apparatus 10. The lower end portion 65 may support the body portion 61, the plurality of support portions 63, the guide member 50, and the sound output module 30. The lower end portion 65 may be configured to mount the apparatus 10 on the floor. For example, the lower end portion 65 may have a circular shape, but aspects of the present disclosure are not necessarily limited thereto. The support structure 60 may be designed according to the shapes of the sound output module 30 and the guide member 50.

The lighting module 80 may be configured under the guide member 50. The lighting module 80 may be spaced apart from the guide member 50 by a predetermined distance. The lighting module 80 may overlap the opening portion 3100. The lighting module 80 may output light toward the guide member 50. For example, the light emitted from the lighting module 80 may be incident on the guide member 50 and may be output toward the sound output module 30. For example, the lighting module 80 may be a light emitting diode LED, but the aspect of the present disclosure is not limited thereto.

The low-pitched sound generating module 70 may be configured in the lower portion of the supporting structure 60. For example, the low-pitched sound generating module 70 may be received or inserted into the lower end portion 65. For example, the low-pitched sound generating module 70 may be configured to output the sound (or sound wave) of low-pitched sound band. For example, the low-pitched sound generating module 70 may be a speaker configured to produce the low-pitched sound (or sound wave) of 40 Hz to several kHz, but aspects of the present disclosure are not limited thereto. For example, the low-pitched sound generating module 70 may be a woofer, a bass speaker, a low-pitched sound output module, a low-pitched output module, and a low-pitched sound output apparatus. According to an aspect of the present disclosure, the low-pitched sound generating module 70 is configured so that the sound characteristics and/or sound pressure characteristics of the low-pitched sound band may be further improved.

According to an aspect of the present disclosure, the apparatus 10 may include the sound output module 30 including the enclosure 310 having the inner space and the sound generating module 330 provided in the inner space, and the guide member 50 so that it is possible to simultaneously output light and sound to one apparatus 10, and to simplify the structure of the apparatus 10. In addition, the apparatus 10 may improve the sound characteristics and/or sound pressure characteristics and may output the sound in various directions.

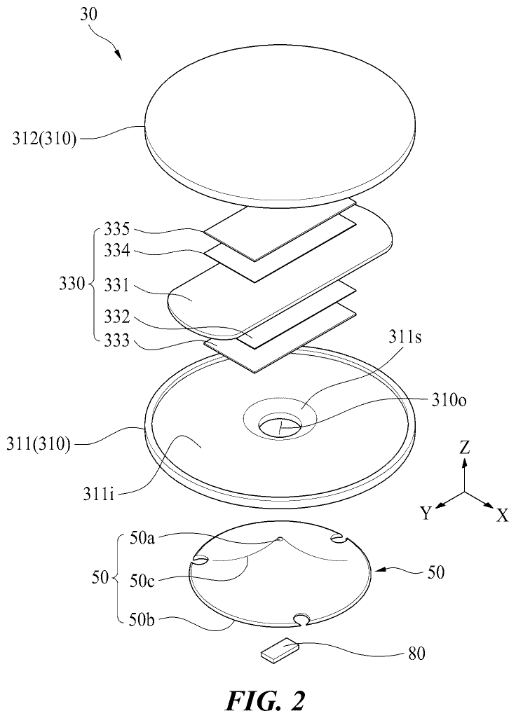

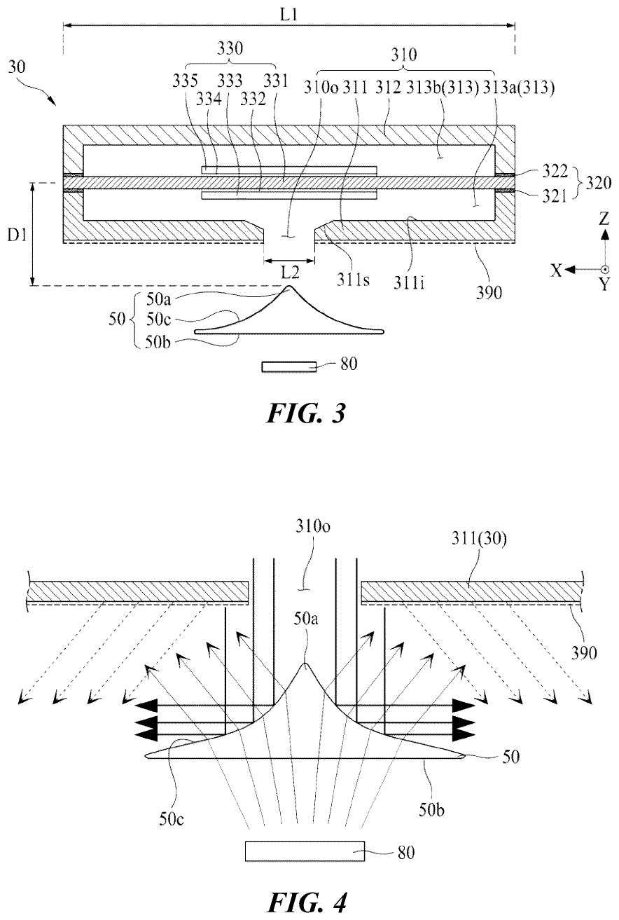

FIG. 2 is an exploded perspective view illustrating a sound output module and a guide member shown in FIG. 1 according to an aspect of the present disclosure. FIG. 3 is a cross-sectional view illustrating a sound output module and a guide member shown in FIG. 1 according to an aspect of the present disclosure.

Referring to FIG. 2 and FIG. 3, the sound output module 30 according to an aspect of the present disclosure may include the enclosure 310 and the sound generating module 330.

The sound generating module 330 according to an aspect of the present disclosure may include a vibration member 331 and vibration apparatuses 333 and 335.

The vibration apparatus 333 and 335 according to an embodiment of the present disclosure can be configured to vibrate the vibration member 331. For example, the vibration apparatus 333 and 335 can be disposed or configured at the vibration member 331. The vibration apparatus 333 and 335 can vibrate (or displace or drive) based on a driving signal (or a vibration driving signal or a voice signal) applied thereto to vibrate (or displace or drive) the vibration member 331. The vibration apparatus 333 and 335 can be disposed with the vibration member 331 therebetween. The vibration apparatus 333 and 335 can include one or more vibration apparatuses. For example, one or more vibration apparatuses 333 and 335 can be configured at the vibration member 331.

The vibration apparatus 333 and 335 according to an embodiment of the present disclosure can include a first vibration apparatus 333 and a second vibration apparatus 335. The first vibration apparatus 333 and the second vibration apparatus 335 can be configured at the vibration member 331.

The vibration member 331 can generate a vibration or can output a sound (or a sound wave), based on the displacements (or driving) of the first vibration apparatus 333 and the second vibration apparatus 335. For example, the vibration member 331 can be a plate, a vibration plate, a vibration object, a vibration panel, a sound plate, a sound panel, a passive vibration plate, a passive vibration member, a passive vibration panel, a sound output plate, or a sound vibration plate, but embodiments of the present disclosure are not limited thereto. For example, the vibration member 331 can include a metal material, or can include a single nonmetal material or a composite nonmetal material of one or more of wood, rubber, plastic, carbon, glass, fiber, cloth, paper, mirror, and leather, but embodiments of the present disclosure are not limited thereto. For example, the paper can be cone paper for speakers. For example, the cone paper can be pulp or foamed plastic, or the like, but embodiments of the present disclosure are not limited thereto.

For example, the metal material of the vibration member 331 can include any one or more materials of stainless steel, aluminum (Al), an Al alloy, a magnesium (Mg), a Mg alloy, and a magnesium-lithium (Mg—Li) alloy, but embodiments of the present disclosure are not limited thereto.

For example, the vibration member 331 can be configured in a metal material such as aluminum (Al) material, or configured in a plastic material such as plastic or styrene material, but embodiments of the present disclosure are not limited thereto. For example, the styrene material can be an ABS material. The ABS material can be acrylonitrile, butadiene, or styrene. For example, the vibration member 331 can be carbon fiber reinforced plastic (CFRP), polypropylene, or polycarbonate, or the like, but embodiments of the present disclosure are not limited thereto.

The vibration member 331 can include a first surface and a second surface different from (or opposite to) the first surface. The first vibration apparatus 333 can be disposed at the first surface (or a rear surface) of the vibration member 331. The second vibration apparatus 335 can be disposed at the second surface (or a front surface) of the vibration member 331.

The first vibration apparatus 333 and the second vibration apparatus 335 can be disposed with the vibration member 331 therebetween. The first vibration apparatus 333 and the second vibration apparatus 335 can vibrate (or displace or drive) based on driving signals (or a vibration driving signal or a voice signal) applied thereto to vibrate (or displace or drive) the vibration member 331. For example, the driving signals (or the vibration driving signal or the voice signal) applied to the first vibration apparatus 333 and the second vibration apparatus 335 can be the same or different. For example, the driving signals applied to the first vibration apparatus 333 and the second vibration apparatus 335 can have the same phase or different phases. For example, the first vibration apparatus 333 and the second vibration apparatus 335 can have a bimorph structure where the first and second vibration apparatuses 333 and 335 are disposed with the vibration member 331 therebetween. Each of the first vibration apparatus 333 and the second vibration apparatus 335 can independently vibrate the vibration member 331, and thus, an influence thereof on a sound characteristic based on a material and a characteristic of the vibration member 331 can be reduced. Accordingly, a sound characteristic and/or a sound pressure level characteristic of the sound output module 30 can be enhanced.

According to another embodiment of the present disclosure, the first vibration apparatus 333 and the second vibration apparatus 335 can be configured at any one of the first surface and the second surface of the vibration member 331. For example, the first vibration apparatus 333 can be configured at any one of the first surface and the second surface of the vibration member 331. For example, the second vibration apparatus 335 can be connected to the first vibration apparatus 333. For example, the second vibration apparatus 335 can be stacked on the first vibration apparatus 333.

The sound output module 30 according to an embodiment of the present disclosure can further include an adhesive member. The adhesive member can include a first adhesive member 332 and a second adhesive member 334.

According to an embodiment of the present disclosure, the first adhesive member 332 can be disposed between the vibration member 331 and the first vibration apparatus 333. The first vibration apparatus 333 can be connected or coupled to the vibration member 331 by the first adhesive member 332. For example, the first vibration apparatus 333 can be connected or coupled to the first surface of the vibration member 331 by the first adhesive member 332.

According to an embodiment of the present disclosure, the second adhesive member 334 can be disposed between the vibration member 331 and the second vibration apparatus 335. The second vibration apparatus 335 can be connected or coupled to the vibration member 331 by the second adhesive member 334. For example, the second vibration apparatus 335 can be connected or coupled to the second surface of the vibration member 331 by the second adhesive member 334.

The first adhesive member 332 and the second adhesive member 334 can include an adhesive layer (or a tacky layer) which is good in adhesive force or attaching force. For example, the first adhesive member 332 and the second adhesive member 334 can include a same or different adhesive layers (or tacky layers). For example, the first adhesive member 332 and the second adhesive member 334 can include an adhesive, a double-sided adhesive, a double-sided tape, a double-sided adhesive tape, a double-sided adhesive foam tape, a double-sided foam pad, a double-sided adhesive foam pad, a double-sided cushion tape, or a tacky sheet, but embodiments of the present disclosure are not limited thereto.

According to an embodiment of the present disclosure, the enclosure 310 can include at least one or more enclosures 311 and 312. The at least one or more enclosures 311 and 312 can include a first enclosure 311 and a second enclosure 312. For example, the second enclosure 312 can be connected to the first enclosure 311. For example, the enclosure 310 can be a housing, a case, an outer case, a case member, a housing member, a cabinet, a sealing member, a scaling cap, a scaling box, a sound box, or the like, but embodiments of the present disclosure are not limited thereto.

The enclosure 310 according to an embodiment of the present disclosure can include one or more of a metal material and a nonmetal material (or a composite nonmetal material), but embodiments of the present disclosure are not limited thereto. For example, the enclosure 310 can include one or more materials of a metal material, plastic, and wood, but embodiments of the present disclosure are not limited thereto. For example, the enclosure 310 can be configured in a metal material such as aluminum (Al) material, or configured in a plastic material such as plastic or styrene material, but embodiments of the present disclosure are not limited thereto. For example, the styrene material can be an ABS material. The ABS material can be acrylonitrile, butadiene, or styrene. For example, when the enclosure 310 is made of a non-metallic material or plastic, a reflective layer 390 for reflecting light output from the guide member 50 downward may be additionally formed on an outer surface (or rear surface) of a first enclosure 311 facing the guide member 50. For example, the reflective layer 390 may be configured by coating a light reflective material onto the outer surface (or rear surface) of the first enclosure 311, but aspects of the present disclosure are not necessarily limited thereto.

The enclosure 310 can include an internal space 313. The internal space 313 can be between the first enclosure 311 and the second enclosure 312. For example, the sound generating module 330 can be configured at the internal space 313 of the enclosure 310. For example, the sound generating module 330 can be configured at the internal space 313 between the first enclosure 311 and the second enclosure 312. The vibration apparatus of the sound generating module 330 can be at the internal space 313 of the enclosure 310. For example, the first vibration apparatus 333 and the second vibration apparatus 335 of the sound generating module 330 can be at the internal space 313 of the enclosure 310. The first vibration apparatus 333 and the second vibration apparatus 335 can be at different spaces in the internal space 313 of the enclosure 310.

According to an aspect of the present disclosure, the inner space 313 of the enclosure 310 may include a first space 313a and a second space 313b. For example, the first space 313a may be between a first surface of the sound generating module 330 and the first enclosure 311. The first space 313a may be between the first vibration apparatus 333 and the first enclosure 311. For example, the second space 313b may be between a second surface different from (or opposite to) the first surface of the sound generating module 330 and the second enclosure 312. The second space 313b may be between the second vibration apparatus 335 and the second enclosure 312. For example, the inner space 313 may be a gap space, an air gap, a vibration space, an acoustic space, an echoing box, or a sealed space, but aspects of the present disclosure are not limited thereto.

According to an aspect of the present disclosure, the first enclosure 311 can include an opening portion 3100.

The opening portion 3100 can be configured to pass through the first enclosure 311 in a thickness direction Z (or a vertical direction) of the enclosure 310. The opening portion 3100 can be connected to (or communicate with) the internal space 313. For example, the opening portion 3100 can be configured to decrease an air pressure of the internal space 313 of the enclosure 310. For example, the opening portion 3100 can be connected to (or communicate with) the first space 313a. The opening portion 3100 can be configured to decrease an air pressure of the first space 313a of the first enclosure 311 or an air pressure of the first space 313a provided between the vibration member 331 and the first enclosure 311. Therefore, a band of the low-pitched sound band can extend, and thus, a sound characteristic of the low-pitched sound band can be improved. Because a pressure (or air pressure) of the first space 313a is reduced by the opening portion 3100, the amount of displacement (or a bending force) of the first vibration apparatus 333 disposed between the vibration member 331 and the first enclosure 311 can increase, and thus, a band of the low-pitched sound band can extend, thereby enhancing a sound characteristic and/or a sound pressure level characteristic of the low-pitched sound band. Accordingly, a sound characteristic (or a sound pressure level) of the low-pitched sound band generated based on a vibration of the first vibration apparatus 333 and/or the second vibration apparatus 335 can be improved.

According to an aspect of the present disclosure, the opening portion 3100 may be smaller than the size of the first vibration apparatus 333. For example, the opening portion 3100 may be smaller than the first vibration apparatus 333 disposed in the vibration member 331 in size. For example, the opening portion 3100 may have a circular or line shape having a size (or length) smaller than that of the first vibration apparatus 333 disposed in the vibration member 331, but aspects of the present disclosure are not limited thereto. The opening portion 3100 may be configured in various shapes. According to an aspect of the present disclosure, a length L2 of the opening portion 3100 may be 50% or less of a length L1 of the enclosure 310, but aspects of the present disclosure are not limited thereto. For example, when the length L2 of the opening portion 3100 is greater than 50% of the length L1 of the enclosure 310, the sound wave generated from the sound generating module 330 may not be easily propagated (or transmitted) to the external space.

For example, in the apparatus 10 according to an aspect of the present disclosure, if the length L2 of the opening portion 3100 is 50% or less of the length L1 of the enclosure 310 and may be configured to be smaller than that of the sound generating module 330, the sound wave (or sound) generated from the sound generating module 330 may be easily output to the external space. For example, the opening portion 3100 may be a hole, a slot, or a slit, but aspects of the present disclosure are not limited thereto. For example, the opening portion 3100 may be a sound emitting portion, a sound emitting hole, a sound output portion, a sound output port, a sound output hole, or a vent hole, but aspects of the present disclosure are not limited thereto.

The opening portion 3100 can be a space where a sound wave generated based on a vibration of the sound generating module 330 is propagated (or transferred) to an indoor space of a vehicle. Accordingly, a vibration width (or a displacement width) of the vibration member 331 based on a vibration of the sound generating module 330 can increase, and thus, a sound characteristic and/or a sound pressure level characteristic generated based on a vibration of the vibration member 331 can be enhanced.

According to an aspect of the present disclosure, the opening portion 3100 may overlap the guide member 50. The opening portion 3100 may be spaced apart from the guide member 50 by a predetermined distance. Accordingly, the sound wave generated according to the vibration of the sound generating module 330 may be output in the direction toward the guide member 50 through the opening portion 3100.

The first enclosure 311 can be disposed closer to the vehicle interior material than the second enclosure 312. For example, the first enclosure 311 including the opening portion 3100 can be disposed closer to the vehicle interior material than the second enclosure 312. Accordingly, a sound generated based on vibrations of one or more of the first vibration apparatus 333 and the second vibration apparatus 335 can be output to the indoor space of the vehicle, and thus, a sound including the low-pitched sound band can be output to the indoor space of the vehicle.

The first enclosure 311 can include a slope surface (or an inclined surface) 311s and an inner lateral surface 311i. The slope surface 311s can be configured to be inclined between the opening portion 3100 and the inner lateral surface 311i of the first enclosure 311. The slope surface 311s can be configured to guide a sound, generated based on a vibration of the sound generating module 330, to the indoor space of the vehicle. Accordingly, a sound generated based on a vibration of the sound generating module 330 can be output to the indoor space of the vehicle, and a sound characteristic and/or a sound pressure level characteristic of a sound including the low-pitched sound band can be more enhanced. For example, the slope surface 311s can be a guide surface or a sound guide surface, but embodiments of the present disclosure are not limited thereto.

The vibration member 331 can be configured to be spaced apart from the opening portion 3100. The vibration member 331 can be configured at the internal space 313 to be spaced apart from the opening portion 3100. For example, the vibration member 331 can be disposed at the internal space 313 and can be configured between the first enclosure 311 and the second enclosure 312. For example, the vibration member 331 can be disposed at the internal space 313 and can be supported by the first enclosure 311 and the second enclosure 312.

The sound output module 30 according to an embodiment of the present disclosure can further include a coupling member 320. The coupling member 320 can include a first coupling member 321 and a second coupling member 322.

According to an embodiment of the present disclosure, the first enclosure 311 can be disposed or configured at the first surface (or rear surface) of the vibration member 331. The first enclosure 311 can be configured to support a periphery portion (or an edge portion) of the first surface of the vibration member 331. For example, the first enclosure 311 can be configured to support both periphery portions of the first surface of the vibration member 331. The first enclosure 311 can be configured to cover a first surface of the sound generating module 330. For example, the first enclosure 311 can be configured to surround the first surface of the sound generating module 330.

The first coupling member 321 can be between the vibration member 331 and the first enclosure 311. The first coupling member 321 can be between a periphery portion of the vibration member 331 and a periphery portion of the first enclosure 311. For example, the first coupling member 321 can be between both periphery portions of the vibration member 331 and both periphery portions of the first enclosure 311. The periphery portion of the first enclosure 311 can be connected to or coupled to the first surface of the vibration member 331 by the first coupling member 321. For example, the periphery portion of the first enclosure 311 can be connected to or coupled to a periphery portion of the first surface of the vibration member 331 by the first coupling member 321. For example, both periphery portions of the first enclosure 311 can be connected to or coupled to both periphery portions of the first surface of the vibration member 331 by the first coupling member 321.

According to an embodiment of the present disclosure, the second enclosure 312 can be disposed or configured at the second surface (or front surface) which is different from (or opposite to) the first surface of the vibration member 331. The second enclosure 312 can be configured to support a periphery portion of the second surface of the vibration member 331. For example, the second enclosure 312 can be configured to support both periphery portions of the second surface of the vibration member 331. The second enclosure 312 can be configured to cover a second surface of the sound generating module 330. For example, the second enclosure 312 can be configured to surround the second surface of the sound generating module 330.

The second coupling member 322 can be between the vibration member 331 and the second enclosure 312. The second coupling member 322 can be between a periphery portion of the vibration member 331 and a periphery portion of the second enclosure 312. For example, the second coupling member 322 can be between both periphery portions of the vibration member 331 and both periphery portions of the second enclosure 312. The periphery portion of the second enclosure 312 can be connected to or coupled to the second surface of the vibration member 331 by the second coupling member 322. For example, the periphery portion of the second enclosure 312 can be connected to or coupled to a periphery portion of the second surface of the vibration member 331 by the second coupling member 322. For example, both periphery portions of the second enclosure 312 can be connected to or coupled to both periphery portions of the second surface of the vibration member 331 by the second coupling member 322.

According to an embodiment of the present disclosure, the coupling member 320 can be configured to minimize or prevent the transfer of a vibration of the vibration member 331 to the enclosure 310. The coupling member 320 can include a material characteristic suitable for blocking a vibration. For example, the coupling member 320 can include a material having elasticity. For example, the coupling member 320 can include a material having elasticity for vibration absorption (or impact absorption). The coupling member 320 according to an embodiment of the present disclosure can be configured as (or comprise) polyurethane materials and/or polyolefin materials, but embodiments of the present disclosure are not limited thereto. For example, the coupling member 320 can include one or more of an adhesive, a double-sided adhesive, a double-sided tape, a double-sided adhesive tape, a double-sided foam tape, a double-sided adhesive foam tape, a double-sided foam pad, a double-sided adhesive foam pad, and a double-sided cushion tape, but embodiments of the present disclosure are not limited thereto.

The coupling member 320 according to another embodiment of the present disclosure can be configured to minimize or prevent the transfer of a vibration of the vibration member 331 to the enclosure 310 and to decrease the reflection of an incident sound wave which is generated based on a vibration of the vibration member 331.

The sound output module 30 according to an embodiment of the present disclosure can include the sound generating module 330 having the bimorph structure, and thus, a sound characteristic and/or a sound pressure level characteristic of a sound including the low-pitched sound band can be enhanced. Because the sound output module 30 according to an embodiment of the present disclosure includes the enclosure 310 including the opening portion 3100, an air pressure of the internal space 313 of the enclosure 310 can be reduced, and thus, a band of the low-pitched sound band can extend, thereby improving a sound characteristic and/or a sound pressure level characteristic of the low-pitched sound band.

Referring to FIGS. 2 and 3, the guide member 50 according to an aspect of the present disclosure may be configured under the sound output module 30. The guide member 50 according to the aspect of the present disclosure may be spaced apart from the sound output module 30. According to an aspect of the present disclosure, the guide member 50 may be formed under the first enclosure 311 and may be spaced apart from the first enclosure 311. The guide member 50 may overlap the opening portion 3100 and may be spaced apart from the opening portion 3100.

According to an aspect of the present disclosure, the guide member 50 may include a top portion 50a, a bottom portion 50b, and an inclined portion 50c. The top portion 50a may overlap the central portion of the opening portion 3100. The bottom portion 50b may have a larger size than the opening portion 3100. The inclined portion 50c may be inclined between the top portion 50a and the bottom portion 50b. In one embodiment, the inclined portion 50c continuously and contiguously extends between the top portion 50a and the bottom portion 50b. For example, the bottom portion 50b may have a circular shape, and the inclined portion 50c may include a curved shape. For example, the inclined portion 50c may be rounded, and ‘R’ value of an inclined surface may be ‘100’, but not limited thereto. The inclined portion 50c may be inclined or configured in a curved shape (or lens shape) to guide the sound output from the sound output module 30. According to an aspect of the present disclosure, the inclined portion 50c is configured so that it is possible to further improve the sound characteristics and/or sound pressure characteristics of the sound including the low-pitched sound band. For example, the inclined portion 50c may be a guide surface or a sound guide surface, but aspects of the present disclosure are not limited thereto. For example, the guide member 50 may be a light diffusion lens, but aspects of the present disclosure are not limited thereto. The guide member 50 according to an aspect of the present disclosure may be a sound guide member, a light guide member, a sound diffusion member, a light diffusion member, a reflective member, a sound reflective member, a light reflective member, or a lens member.

According to an aspect of the present disclosure, a distance between the guide member 50 and the center of the vibration member 331 may be 55 mm or less, but aspects of the present disclosure are not limited thereto. For example, the distance D1 between the uppermost layer (or vertex) of the guide member 50 and the center of the vibration member 331 may be 55 mm or less. For example, the distance D1 between the top portion 50a of the guide member 50 and the center of the vibration member 331 may be 55 mm or less. For example, the inventors of the present disclosure have performed various experiments to optimize the distribution of omni-directional sound components. When the distance D1 between the uppermost layer (or vertex) of the guide member 50 and the center of the vibration member 331 is 55 mm or less, as shown in FIG. 17 below, the sound (or sound wave) output from the sound output module 30 is distributed in various directions (or 360° directions). For example, the guide member 50 may have a length which is smaller than the length L1 of the first enclosure 311 and longer than the length L2 of the opening portion 3100.

According to an aspect of the present disclosure, the lighting module 80 may be configured to output the light to the top portion 50a and the inclined portion 50c of the guide member 50. The light from the lighting module 80 may be diffused upward by the top portion 50a and the inclined portion 50c of the guide member 50.

According to an aspect of the present disclosure, since the guide member 50 is configured under the sound output module 30, the sound (or sound wave) output from the sound output module 30 may be diffused in various directions (or 360° directions), and the light output from the lighting module 80 may be diffused in various directions (or 360° directions).

According to an aspect of the present disclosure, the apparatus 10 may output the light and sound, and the structure of the apparatus 10 may be simplified. Further, the apparatus 10 may improve the sound characteristics and/or sound pressure characteristics and may output the sound in various directions.

FIG. 4 is a diagram illustrating a sound output direction and a lighting apparatus according to an aspect of the present disclosure. This is a diagram illustrating a sound output direction and a lighting apparatus according to an aspect of the present disclosure illustrated in FIG. 3. An arrow marked with a thick solid line in FIG. 4 indicates an output direction of sound (or sound wave) generated by the sound output module 30. An arrow marked with a thin solid line indicates an output direction of light output from the lighting module 80 and guided by the guide member 50. An arrow marked with a thin dotted line indicates an output direction of light reflected by the sound output module 30.

Referring to FIG. 4, the sound (or sound wave) generated by the sound output module 30 according to an aspect of the present disclosure may be output through the opening portion 3100. The sound (or sound wave) output through the opening portion 3100 may be diffused by the inclined portion 50c of the guide member 50 and may be output to the side surface of the guide member 50. For example, the inclined portion 50c may be configured to guide the sound output from the sound output module 30. Accordingly, the sound characteristics and/or sound pressure characteristics of the sound including the low-pitched sound band may be further improved.

According to an aspect of the present disclosure, the light generated from the guide member 50 may be output toward the sound output module 30. The light output in the direction toward the sound output module 30 may be reflected on the outer surface of the first enclosure 311 and diffused in the direction toward the lower part of the sound output module 30. For example, the light output from the lighting module 80 may be firstly diffused through the guide member 50, and the firstly diffused light may be reflected on the outer surface (or lower surface) of the first enclosure 311 and may be diffused secondly.

Accordingly, according to an aspect of the present disclosure, the apparatus 10 may output the light and sound, and the structure of the apparatus 10 may be simplified. Further, the apparatus 10 may improve the sound characteristics and/or sound pressure characteristics and may output the sound in various directions.

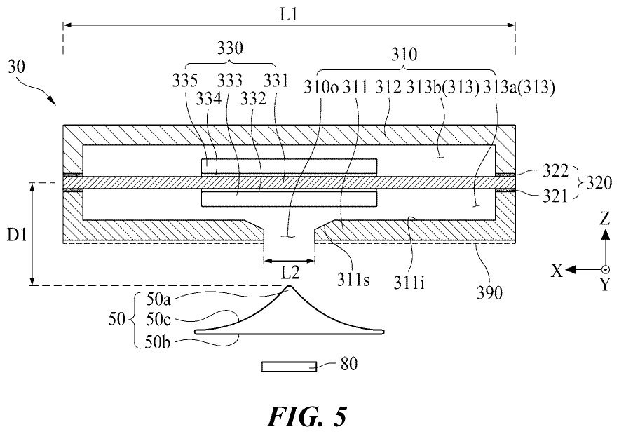

FIG. 5 is a cross-sectional view illustrating a sound output module and a guide member shown in FIG. 1 according to another aspect of the present disclosure.

Referring to FIG. 5, an apparatus according to another aspect of the present disclosure may include a sound output module 30, a guide member 50, and a lighting module 80. The sound output module 30 may include an enclosure 310, a sound generating module 330, and a connection member 320. Since descriptions of the sound output module 30, the guide member 50, and the lighting module 80 are substantially the same as those described with reference to FIGS. 1 to 3, the same reference numerals are assigned to the same components, and a redundant description thereof will be omitted.

The sound generating module 330 according to another aspect of the present disclosure may include vibration apparatuses 333 and 335 including one or more vibration generators. For example, the vibration apparatuses 333 and 335 may include one or more vibration generators.

The first vibration apparatus 333 of the vibration apparatuses 333 and 335 may include one or more vibration generators. The first vibration apparatus 333 may include a first vibration generator and a second vibration generator. For example, the first vibration generator may be disposed or stacked in the second vibration generator.

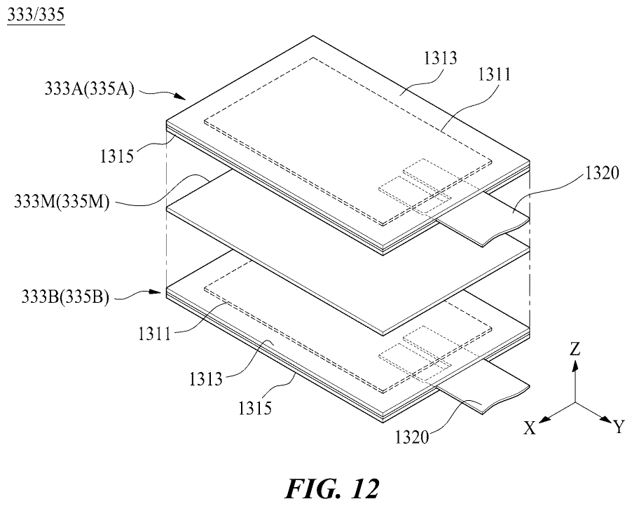

The second vibration apparatus 335 of the vibration apparatuses 333 and 335 may include one or more vibration generators. The second vibration apparatus 335 may include a first vibration generator and a second vibration generator. For example, the first vibration generator may be disposed or stacked in the second vibration generator. The vibration apparatuses 333 and 335 including one or more vibration generators will be described later with reference to FIG. 12.

According to another aspect of the present disclosure, the vibration apparatuses 333 and 335 including one or more vibration generators may be configured on a first surface or a second surface of a vibration member 331. For example, one of the first vibration apparatus 333 and the second vibration apparatus 335 including one or more vibration generators may be configured only on the first surface of the vibration member 331. For example, one of the first vibration apparatus 333 and the second vibration apparatus 335 including one or more vibration generators may be disposed in a first space 313a. For example, the first vibration apparatus 333 including one or more vibration generators may be provided on the first surface of the vibration member 331, and the second vibration apparatus 335 including one or more vibration generators may be omitted.

According to another aspect of the present disclosure, one of the first vibration apparatus 333 and the second vibration apparatus 335 including one or more vibration generators may be configured only on the second surface of the vibration member 331. For example, one of the first vibration apparatus 333 and the second vibration apparatus 335 including one or more vibration generators may be disposed in a second space 313b. For example, the second vibration apparatus 335 including one or more vibration generators may be configured on the second surface of the vibration member 331, and the first vibration apparatus 333 including one or more vibration generators may be omitted.

The vibration apparatuses 333 and 335 according to another aspect of the present disclosure may include one or more vibration generators stacked (or overlapped) to vibrate (or displacement or drive) in the same direction so that it is possible to maximize or increase displacement or amplitude displacement, thereby maximizing or increasing the displacement (or bending force or driving force) or amplitude displacement of vibration member 331.

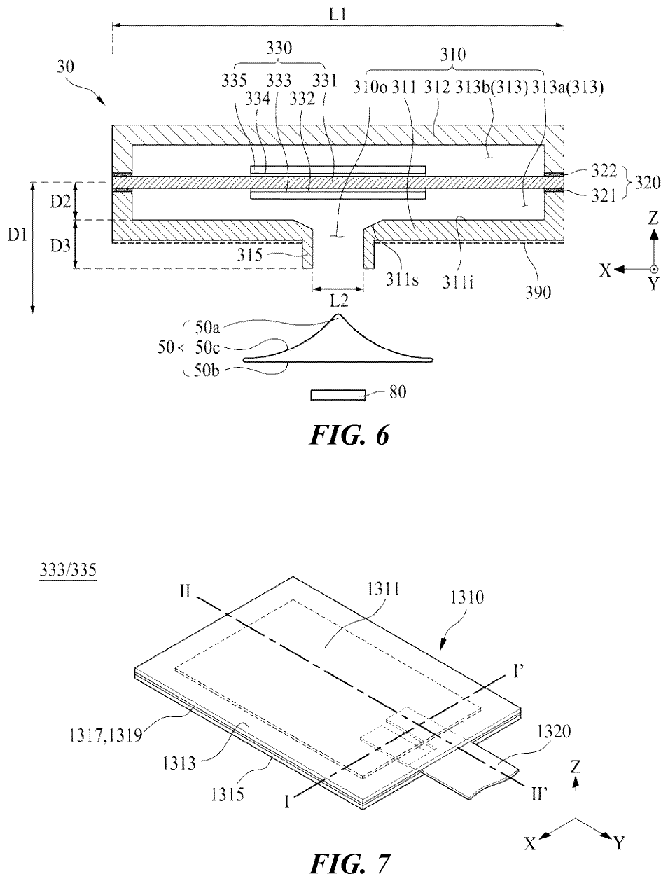

FIG. 6 is a cross-sectional view illustrating a sound output module and a guide member shown in FIG. 1 according to another aspect of the present disclosure.

Referring to FIG. 6, an apparatus according to another aspect of the present disclosure may include a sound output module 30, a guide member 50, and a lighting module 80. The sound output module 30 may include an enclosure 310, a sound generating module 330, and a connection member 320. Since descriptions of the sound output module 30, the guide member 50, and the lighting module 80 are substantially the same as those described with reference to FIGS. 1 to 3, the same reference numerals are assigned to the same components, and a redundant description thereof will be omitted.

According to another aspect of the disclosure, the enclosure 310 may include a protrusion 315. A first enclosure 311 may include a protrusion 315. The protrusion 315 may protrude from the first enclosure 311. For example, the first enclosure 311 may include an inner surface and an outer surface. The inner surface of the first enclosure 311 may face a vibration member 331. The outer surface of the first enclosure 311 may be a surface opposite to the inner surface of the first enclosure 311. For example, the protrusion 315 may protrude from a rear surface (or outer surface) of the first enclosure 311. The protrusion 315 may surround an opening portion 3100 of the enclosure 310. For example, the protrusion 315 may surround the opening portion 3100 of the first enclosure 311.

According to another aspect of the present disclosure, a distance D2 from the center of the vibration member 331 to the inner surface of the first enclosure 311 may be smaller than a distance D3 from the inner surface of the first enclosure 311 to the end of the protrusion 315. For example, the distance D2 from the center of the vibration member 331 to the inner surface of the first enclosure 311 may be in a range of 1 mm to 4 mm, but embodiments of the present disclosure are not limited thereto. For example, a distance D3 from the inner surface of the first enclosure 311 to the end of the protrusion 315 may be in the range of 4 mm to 10 mm. For example, when the distance D2 from the center of the vibration member 331 to the inner surface of the first enclosure 311 is 2.5 mm, the distance D3 from the inner surface of the first enclosure 311 to the end of the protrusion 315 may be 4.5 mm.

According to another aspect of the present disclosure, since the protrusion is further configured in the enclosure 310, the sound (or sound wave) generated from the sound generating module 330 may be more easily output in the downward direction.

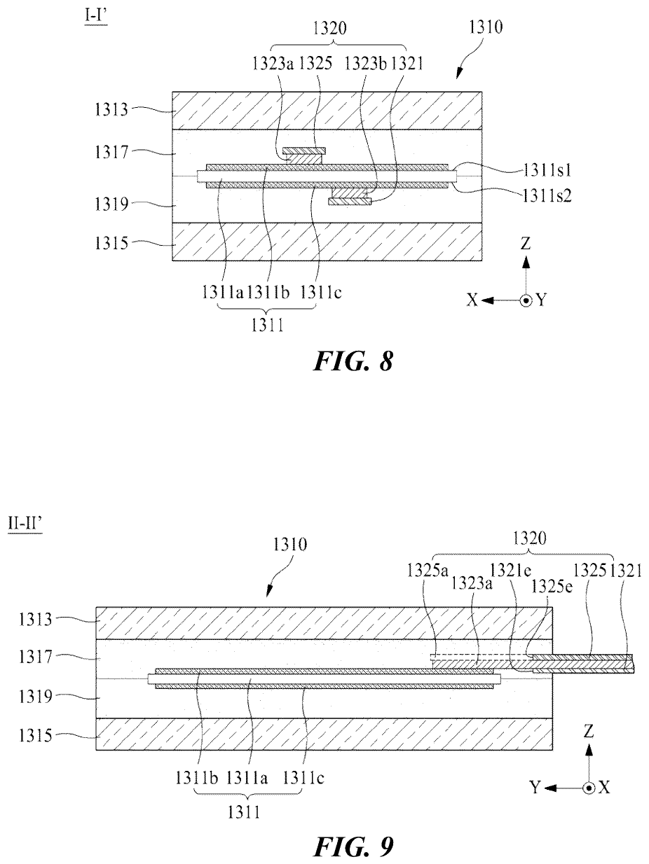

FIG. 7 is a diagram illustrating a vibration apparatus according to an aspect of the present disclosure. FIG. 8 is a cross-sectional view taken along line I-I′ of FIG. 7 according to an aspect of the present disclosure. FIG. 9 is a cross-sectional view taken along line II-II′ of FIG. 7 according to an aspect of the present disclosure.

Referring to FIGS. 7 to 9, a sound generating module 330 according to an embodiment of the present disclosure can include a vibration apparatus 333 and 335. The vibration apparatus 333 and 335 can include one or more vibration generator 1310.

The vibration generator 1310 can include a piezoelectric material having a piezoelectric characteristic. The vibration generator 1310 can vibrate (or displace or drive) a vibration member (or a vehicle interior material) based on a vibration (or displacement or driving) of the piezoelectric material based on an electric signal (or a voice signal or a sound signal) applied to the piezoelectric material. For example, the vibration generator 1310 can alternately repeat contraction and/or expansion by a piezoelectric effect (or a piezoelectric characteristic) to vibrate (or displace or drive). For example, the vibration generator 1310 can vibrate (or displace or drive) in a vertical direction (or a thickness direction) Z as contraction and/or expansion are alternately repeated by an inverse piezoelectric effect.

The vibration generator 1310 can be configured as a ceramic-based piezoelectric material capable of implementing a relatively strong vibration, or can be configured as a piezoelectric ceramic having a perovskite-based crystal structure. For example, the vibration generator 1310 can be a vibration generating device, a vibration film, a vibration generating film, a vibrator, an active vibrator, an active vibration generator, an actuator, an exciter, a film actuator, a film exciter, an ultrasonic actuator, or an active vibration member, or the like, but embodiments of the present disclosure are not limited thereto.

The vibration generator 1310 according to an embodiment of the present disclosure can include a vibration generating part 1311.

The vibration generating part 1311 can be configured to vibrate by the piezoelectric effect based on a driving signal. For example, the vibration generating part 1311 can include a piezoelectric type vibration portion or a piezoelectric vibration portion. The vibration generating part 1311 can include at least one or more of a piezoelectric inorganic material and a piezoelectric organic material. For example, the vibration generating part 1311 can be a vibration device, a piezoelectric device, a piezoelectric device part, a piezoelectric device layer, a piezoelectric structure, a piezoelectric vibration portion, or a piezoelectric vibration layer, or the like, but embodiments of the present disclosure are not limited thereto.

The vibration generating part 1311 according to an embodiment of the present disclosure can include a vibration portion 1311a, a first electrode portion 1311b, and a second electrode portion 1311c.

The vibration portion 1311a can include a piezoelectric material or an electroactive material which includes a piezoelectric effect. For example, the piezoelectric material can have a characteristic in which, when pressure or twisting phenomenon is applied to a crystalline structure by an external force, a potential difference occurs due to dielectric polarization caused by a relative position change of a positive (+) ion and a negative (−) ion, and thus a vibration is generated by an electric field based on a reverse voltage applied thereto. For example, the vibration portion 1311a can be a piezoelectric layer, a piezoelectric material layer, an electroactive layer, a piezoelectric composite layer, a piezoelectric composite, or a piezoelectric ceramic composite, or the like, but embodiments of the present disclosure are not limited thereto.

The vibration portion 1311a can be configured as a ceramic-based material capable of implementing a relatively strong vibration, or can be configured as a piezoelectric ceramic having a perovskite-based crystalline structure. The perovskite crystalline structure can have a piezoelectric effect and/or an inverse piezoelectric effect and can be a plate-shaped structure having orientation or alignment. The perovskite crystalline structure can be represented by a chemical formula “ABO₃”. In the chemical formula, “A” can include a divalent metal element, and “B” can include a tetravalent metal element. As an embodiment of the present disclosure, in the chemical formula “ABO₃”, “A”, and “B” can be cations, and “O” can be anions. For example, the vibration portion 1311a can include at least one or more of lead titanate (PbTiO₃), lead zirconate (PbZrO₃), lead zirconate titanate (PbZrTiO₃), barium titanate (BaTiO₃), and strontium titanate (SrTiO₃), but embodiments of the present disclosure are not limited thereto.

The piezoelectric ceramic can be configured as a single crystalline ceramic having a crystalline structure, or can be configured as a ceramic material having a polycrystalline structure or polycrystalline ceramic. A piezoelectric material including the single crystalline ceramic can include α-AlPO₄, α-SiO₂, LiNbO₃, Tb₂(MoO₄)₃, Li₂B₄O₇, or ZnO, but embodiments of the present disclosure are not limited thereto. A piezoelectric material including the polycrystalline ceramic can include a lead zirconate titanate (PZT)-based material, including lead (Pb), zirconium (Zr), and titanium (Ti), or can include a lead zirconate nickel niobate (PZNN)-based material, including lead (Pb), zirconium (Zr), nickel (Ni), and niobium (Nb), but embodiments of the present disclosure are not limited thereto. For example, the vibration portion 1311a can include at least one or more of calcium titanate (CaTiO₃), BaTiO₃, and SrTiO₃, without lead (Pb), but embodiments of the present disclosure are not limited thereto.

The first electrode portion 1311b can be disposed at or on a first surface (or an upper surface or a front surface) 1311s1 of the vibration portion 1311a. The first electrode portion 1311b can have a same size as the vibration portion 1311a, or can have a size which is smaller than the vibration portion 1311a.

The second electrode portion 1311c can be disposed at or on a second surface (or a lower surface or a rear surface) 1311s2 which is opposite to or different from the first surface 1311s1 of the vibration portion 1311a. The second electrode portion 1311c can have a same size as the vibration portion 1311a, or can have a size which is smaller than the vibration portion 1311a. For example, the second electrode portion 1311c can have a same shape as the vibration portion 1311a, but embodiments of the present disclosure are not limited thereto.

According to an embodiment of the present disclosure, in order to prevent electrical short circuit between the first electrode portion 1311b and the second electrode portion 1311c, each of the first electrode portion 1311b and the second electrode portion 1311c can be formed at a remaining portion except a periphery portion of the vibration portion 1311a. For example, the first electrode portion 1311b can be formed at an entire remaining portion except a periphery portion of the first surface 1311s1 of the vibration portion 1311a. For example, the second electrode portion 1311c can be formed at an entire remaining portion except a periphery portion of the second surface 1311s2 of the vibration portion 1311a. For example, a distance between a lateral surface (or a sidewall) of each of the first electrode portion 1311b and the second electrode portion 1311c and a lateral surface (or a sidewall) of the vibration portion 1311a can be at least 0.5 mm or more. For example, the distance between the lateral surface of each of the first electrode portion 1311b and the second electrode portion 1311c and the lateral surface of the vibration portion 1311a can be at least 1 mm or more, but embodiments of the present disclosure are not limited thereto.

One or more of the first electrode portion 1311b and the second electrode portion 1311c according to an embodiment of the present disclosure can be formed of a transparent conductive material, a semitransparent conductive material, or an opaque conductive material. For example, the transparent conductive material or the semitransparent conductive material can include indium tin oxide (ITO) or indium zinc oxide (IZO), but embodiments of the present disclosure are not limited thereto. The opaque conductive material can include gold (Au), silver (Ag), platinum (Pt), palladium (Pd), molybdenum (Mo), magnesium (Mg), carbon, or silver (Ag) including glass frit, or the like, or can be made of an alloy thereof, but embodiments of the present disclosure are not limited thereto. For example, to enhance an electrical characteristic and/or a vibration characteristic of the vibration portion 1311a, each of the first electrode portion 1311b and the second electrode portion 1311c can include silver (Ag) having a low resistivity. For example, the carbon can include a carbon material including one or more of carbon black, ketjen black, carbon nanotube, and graphite, but embodiments of the present disclosure are not limited thereto.

The vibration portion 1311a can be polarized (or poling) by a certain voltage applied to the first electrode portion 1311b and the second electrode portion 1311c in a certain temperature atmosphere, or a temperature atmosphere that can be changed from a high temperature to a room temperature, but embodiments of the present disclosure are not limited thereto. For example, a polarization direction (or a poling direction) formed in the vibration portion 1311a can be formed or aligned (or arranged) from the first electrode portion 1311b to the second electrode portion 1311c, but embodiments of the present disclosure are not limited thereto. For example, the polarization direction (or the poling direction) formed in the vibration portion 1311a can be formed or aligned (or arranged) from the second electrode portion 1311c to the first electrode portion 1311b.

The vibration portion 1311a can alternately and repeatedly contract and/or expand by an inverse piezoelectric effect based on a driving signal applied to the first electrode portion 1311b and the second electrode portion 1311c from the outside to vibrate. For example, the vibration portion 1311a can vibrate in a vertical direction (or thickness direction) and in a planar direction by the signal applied to the first electrode portion 1311b and the second electrode portion 1311c. The vibration portion 1311a can be displaced (or vibrated or driven) by contraction and/or expansion of the planar direction, thereby improving a sound characteristic and/or a sound pressure level characteristic of the vibration generator 1310.

The vibration generator 1310 according to an embodiment of the present disclosure can further include a first cover member 1313 and a second cover member 1315.

The first cover member 1313 can be disposed at a first surface of the vibration generating part 1311. For example, the first cover member 1313 can be configured to cover the first electrode portion 1311b of the vibration generating part 1311. For example, the first cover member 1313 can be in or at the first electrode portion 1311b. For example, the first cover member 1313 can be configured to have a larger size than the vibration generating part 1311. The first cover member 1313 can be configured to protect the first surface of the vibration generating part 1311 and the first electrode portion 1311b.

The second cover member 1315 can be disposed at a second surface of the vibration generating part 1311. For example, the second cover member 1315 can be configured to cover the second electrode portion 1311c of the vibration generating part 1311. For example, the second cover member 1315 can be in or at the second electrode portion 1311c. For example, the second cover member 1315 can be configured to have a larger size than the vibration generating part 1311 and can be configured to have a same size as the first cover member 1313. The second cover member 1315 can be configured to protect the second surface of the vibration generating part 1311 and the second electrode portion 1311c.

The first cover member 1313 and the second cover member 1315 according to an embodiment of the present disclosure can include a same material or a different material. For example, each of the first cover member 1313 and the second cover member 1315 can be a polyimide (PI) film, a polyethylene terephthalate (PET) film, or a polyethylene naphthalate (PEN) film, but embodiments of the present disclosure are not limited thereto.

The first cover member 1313 can be connected or coupled to the first surface of the vibration generating part 1311 or the first electrode portion 1311b by a first adhesive layer 1317. For example, the first cover member 1313 can be connected or coupled to the first surface of the vibration generating part 1311 or the first electrode portion 1311b by a film laminating process using the first adhesive layer 1317.

The second cover member 1315 can be connected or coupled to the second surface of the vibration generating part 1311 or the second electrode portion 1311c by a second adhesive layer 1319. For example, the second cover member 1315 can be connected or coupled to the second surface of the vibration generating part 1311 or the second electrode portion 1311c by a film laminating process using the second adhesive layer 1319.

Each of the first adhesive layer 1317 and second adhesive layer 1319 according to an embodiment of the present disclosure can include an electrically insulating material which has adhesiveness and is capable of compression and decompression. For example, each of the first adhesive layer 1317 and the second adhesive layer 1319 can include an epoxy resin, an acrylic resin, a silicone resin, or a urethane resin, but embodiments of the present disclosure are not limited thereto.

The first adhesive layer 1317 and second adhesive layer 1319 can be configured between the first cover member 1313 and the second cover member 1315 to surround the vibration generating part 1311. For example, one or more of the first adhesive layer 1317 and second adhesive layer 1319 can be configured to surround the vibration generating part 1311.

Any one of the first cover member 1313 and the second cover member 1315 can be connected or coupled to the vibration member 331 by the adhesive member 321 and 322 illustrated in FIGS. 3 to 6.

The vibration generator 1310 according to an embodiment of the present disclosure can further include a signal supply member 1320.

The signal supply member 1320 can be configured to supply the driving signal supplied from a driving circuit part to the vibration generating part 1311. The signal supply member 1320 can be configured to be electrically connected to the vibration portion 1311a. The signal supply member 1320 can be configured to be electrically connected to the first electrode portion 1311b and the second electrode portion 1311c of the vibration generating part 1311.

A portion of the signal supply member 1320 can be accommodated (or inserted) between the first cover member 1313 and the second cover member 1315. An end portion (or a distal end portion or one side) of the signal supply member 1320 can be disposed or inserted (or accommodated) between one edge portion (or one periphery portion) of the first cover member 1313 and one edge portion (or one periphery portion) of the second cover member 1315. The one edge portion of the first cover member 1313 and the one edge portion of the second cover member 1315 can accommodate or vertically (or up and down) cover the end portion (or the distal end portion or the one side) of the signal supply member 1320. Accordingly, the signal supply member 1320 can be integrated (or configured) as one body with the vibration generating part 1311. Accordingly, the sound generating module 330 or the vibration apparatus 333 and 335 can be implemented (or configured) in a film type integrated with the signal supply member 1320. For example, the signal supply member 1320 can be configured as one part (or one component) with the vibration generating part 1311, thereby realizing an effect of uni-materialization. For example, the signal supply member 1320 can be configured as a signal cable, a flexible cable, a flexible printed circuit cable, a flexible flat cable, a single-sided flexible printed circuit, a single-sided flexible printed circuit board, a flexible multilayer printed circuit, or a flexible multilayer printed circuit board, but embodiments of the present disclosure are not limited thereto.

The signal supply member 1320 according to an embodiment of the present disclosure can include a base member 1321 and a plurality of signal lines 1323a and 1323b. For example, the signal supply member 1320 can include a base member 1321, a first signal line 1323a, and a second signal line 1323b.

The base member 1321 can include a transparent or opaque plastic material, but embodiments of the present disclosure are not limited thereto. The base member 1321 can have a certain width along a first direction X and can be extended long along a second direction Y intersecting with the first direction X.

The first signal line 1323a and the second signal line 1323b can be disposed at the first surface of the base member 1321 in parallel with the second direction Y and can be spaced apart from each other or electrically separated from each other along the first direction X. The first signal line 1323a and the second signal line 1323b can be disposed in parallel to each other at the first surface of the base member 1321. For example, the first signal line 1323a and the second signal line 1323b can be implemented in a line shape by patterning of a metal layer (or a conductive layer) formed or deposited at the first surface of the base member 1321.

End portions (or distal end portions or one sides) of the first signal line 1323a and the second signal line 1323b can be separated from each other, and thus, can be individually curved or bent.

The end portion (or the distal end portion or the one side) of the first signal line 1323a can be electrically connected to the first electrode portion 1311b of the vibration generating part 1311. For example, the end portion of the first signal line 1323a can be electrically connected to at least a portion of the first electrode portion 1311b of the vibration generating part 1311 in the one edge portion of the first cover member 1313. For example, the end portion (or the distal end portion or the one side) of the first signal line 1323a can be electrically and directly connected to at least a portion of the first electrode portion 1311b of the vibration generating part 1311. For example, the end portion (or the distal end portion or the one side) of the first signal line 1323a can be electrically connected to or directly contact the first electrode portion 1311b of the vibration generating part 1311. For example, the end portion of the first signal line 1323a can be electrically connected to the first electrode portion 1311b by a conductive double-sided tape. Accordingly, the first signal line 1323a can be configured to transfer a first driving signal, supplied from a driving circuit part (or a vibration driver), to the first electrode portion 1311b of the vibration generating part 1311.

The end portion (or the distal end portion or the one side) of the second signal line 1323b can be electrically connected to the second electrode portion 1311c of the vibration generating part 1311. For example, the end portion of the second signal line 1323b can be electrically connected to at least a portion of the second electrode portion 1311c of the vibration generating part 1311 in the one edge portion of the second cover member 1315. For example, the end portion of the second signal line 1323b can be electrically and directly connected to at least a portion of the second electrode portion 1311c of the vibration generating part 1311. For example, the end portion of the second signal line 1323b can be electrically connected to or directly contact the second electrode portion 1311c of the vibration generating part 1311. For example, the end portion of the second signal line 1323b can be electrically connected to the second electrode portion 1311c by a conductive double-sided tape. Accordingly, the second signal line 1323b can be configured to transfer a second driving signal, supplied from the driving circuit part (or the vibration driver), to the second electrode portion 1311c of the vibration generating part 1311.

The signal supply member 1320 according to an embodiment of the present disclosure can further include an insulation layer 1325.

The insulation layer 1325 can be disposed at the first surface of the base member 1321 to cover each of the first signal line 1323a and the second signal line 1323b other than the end portion (or one side) of the signal supply member 1320.

An end portion (or one side) of the signal supply member 1320 including an end portion (or one side) of the base member 1321 and an end portion (or one side) 1325a of the insulation layer 1325 can be inserted (or accommodated) between the first cover member 1313 and the second cover member 1315 and can be fixed between the first cover member 1313 and the second cover member 1315 by a first adhesive layer 1317 and the second adhesive layer 1319. Accordingly, the end portion (or one side) of the first signal line 1323a can be maintained with being electrically connected to the first electrode portion 1311b of the vibration generating part 1311, and the end portion (or one side) of the second signal line 1323b can be maintained with being electrically connected to the second electrode portion 1311c of the vibration generating part 1311. In addition, the end portion (or one side) of the signal supply member 1320 can be inserted (or accommodated) and fixed between the vibration generating part 1311 and the first cover member 1313, and thus, a contact defect between the vibration generator 1310 and the signal supply member 1320 caused by the movement of the signal supply member 1320 can be prevented.

In the signal supply member 1320 according to an embodiment of the present disclosure, each of the end portion (or one side) of the base member 1321 and the end portion (or one side) 1325a of the insulation layer 1325 can be removed. For example, each of the end portion of the first signal line 1323a and the end portion of the second signal line 1323b can be exposed at the outside without being supported or covered by each of the end portion (or one side) of the base member 1321 and the end portion (or one side) 1325a of the insulation layer 1325, respectively. For example, the end portion (or one side) of each of the first signal line 1323a and the second signal line 1323b can protrude (or extend) to have a certain length from an end 1321e of the base member 1321 or an end 1325e of the insulation layer 1325. Accordingly, the end portion (or the distal end portion or the one side) of each of the first signal line 1323a and the second signal line 1323b can be individually or independently bent.

The end portion (or one side) of the first signal line 1323a, which is not supported by the end portion (or one side) of the base member 1321 and the end portion 1325e of the insulation layer 1325, can be directly connected to or directly contact the first electrode portion 1311b of the vibration generating part 1311. The end portion (or one side) of the second signal line 1323b, which is not supported by the end portion (or one side) of the base member 1321 and the end portion 1325e of the insulation layer 1325, can be directly connected to or directly contact the second electrode portion 1311c of the vibration generating part 1311.

According to an embodiment of the present disclosure, a portion of the signal supply member 1320 or a portion of the base member 1321 can be disposed or inserted (or accommodated) between the first cover member 1313 and the second cover member 1315, and thus, the signal supply member 1320 can be integrated (or configured) as one body with the vibration generating part 1311. Accordingly, the vibration generating part 1311 and the signal supply member 1320 can be configured as one part (or one component), and thus, an effect of uni-materialization can be obtained.

According to an embodiment of the present disclosure, the first signal line 1323a and the second signal line 1323b of the signal supply member 1320 can be integrated (or configured) as one body with the vibration generator 1310, and thus, a soldering process for an electrical connection between the vibration generator 1310 and the signal supply member 1320 may not be needed. Accordingly, a manufacturing process and a structure of the vibration apparatus 333 and 335 can be simplified, and hazards associated with the soldering process can be reduced.

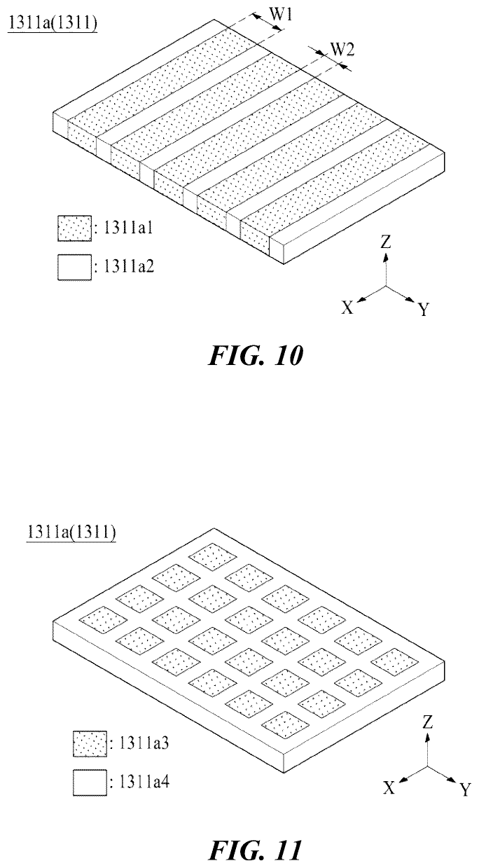

FIG. 10 is a diagram illustrating a vibration portion according to another aspect of the present disclosure. FIG. 10 illustrates another embodiment of the vibration portion described above with reference to FIGS. 7 to 9.

Referring to FIGS. 8 and 10, the vibration portion 1311a according to another embodiment of the present disclosure can include a plurality of first portions 1311a1 and a plurality of second portions 1311a2. For example, the plurality of first portions 1311a1 and the plurality of second portions 1311a2 can be alternately and repeatedly disposed along a first direction X (or a second direction Y).

Each of the plurality of first portions 1311a1 can include an inorganic material portion having a piezoelectric effect (or a piezoelectric characteristic). For example, each of the plurality of first portions 1311a1 can include at least one or more of a piezoelectric inorganic material and a piezoelectric organic material. For example, each of the plurality of first portions 1311a1 can be an inorganic portion, an inorganic material portion, a piezoelectric portion, a piezoelectric material portion, or an electroactive portion, but embodiments of the present disclosure are not limited thereto.

Each of the plurality of first portions 1311a1 can be configured as a ceramic-based material capable of implementing a relatively strong vibration, or can be configured as a piezoelectric ceramic having a perovskite-based crystalline structure. The perovskite crystalline structure can have a piezoelectric effect and/or an inverse piezoelectric effect and can be a plate-shaped structure having orientation or alignment. The perovskite crystalline structure can be represented by a chemical formula “ABO₃”. In the chemical formula, “A” can include a divalent metal element, and “B” can include a tetravalent metal element. As an embodiment of the present disclosure, in the chemical formula “ABO₃”, “A”, and “B” can be cations, and “O” can be anions. For example, the vibration portion 1311a can include at least one or more of PbTiO₃, PbZrO₃, PbZrTiQ₃, BaTiO₃, and SrTiO₃, but embodiments of the present disclosure are not limited thereto.

The piezoelectric ceramic can be configured as a single crystalline ceramic having a crystalline structure, or can be configured as a ceramic material having a polycrystalline structure or polycrystalline ceramic. A piezoelectric material including the single crystalline ceramic can include α-AlPO₄, α-SiO₂, LiNbO₃, Tb₂(MoO₄)₃, Li₂B₄O₇, or ZnO, but embodiments of the present disclosure are not limited thereto. A piezoelectric material including the polycrystalline ceramic can include a lead zirconate titanate (PZT)-based material, including lead (Pb), zirconium (Zr), and titanium (Ti), or can include a lead zirconate nickel niobate (PZNN)-based material, including lead (Pb), zirconium (Zr), nickel (Ni), and niobium (Nb), but embodiments of the present disclosure are not limited thereto. For example, the vibration portion 1311a can include at least one or more of CaTiO₃, BaTiO₃, and SrTiO₃, without lead (Pb), but embodiments of the present disclosure are not limited thereto.

According to an embodiment of the present disclosure, each of the plurality of first portions 1311a1 can have a first width W1 parallel to the second direction Y (or the first direction X) and can be extended along the first direction Y (or the second direction Y). Each of the plurality of first portions 1311a1 can be configured in a material which is substantially a same as a vibration portion 1311a described above with reference to FIGS. 7 to 9, and thus, repeated descriptions thereof are omitted.

Each of the plurality of second portions 1311a2 can be disposed between the plurality of first portions 1311a1. For example, each of the plurality of first portions 1311a1 can be disposed between two adjacent second portions 1311a2 of the plurality of second portions 1311a2. Each of the plurality of second portions 1311a2 can have a second width W2 parallel to the second direction Y (or the first direction X) and can be extended along the first direction X (or the second direction Y). The first width W1 can be a same as or different from the second width W2. For example, the first width W1 can be greater than the second width W2. For example, the first portion 1311a1 and the second portion 1311a2 can include a line shape or a stripe shape which has a same size or different sizes.

Each of the plurality of second portions 1311a2 can be configured to fill a gap between two adjacent first portions of the plurality of first portions 1311a1. Each of the plurality of second portions 1311a2 can be configured to fill a gap between two adjacent first portions of the plurality of first portions 1311a1, and thus, can be connected to or attached on lateral surfaces of the first portion 1311a1 adjacent thereto. According to an embodiment of the present disclosure, each of the plurality of first portions 1311a1 and the plurality of second portions 1311a2 can be disposed (or arranged) on a same plane (or a same layer) in parallel with each other. Therefore, the vibration portion 1311a can be expanded to a desired size or length by a lateral coupling (or connection) of the first portions 1311a1 and the second portions 1311a2.

According to an embodiment of the present disclosure, each of the plurality of second portions 1311a2 can absorb an impact applied to the first portions 1311a1, and thus, can enhance the total durability of the first portions 1311a1 and provide flexibility to the vibration portion 1311a. Each of the plurality of second portions 1311a2 can include an organic material having a ductile characteristic. For example, each of the plurality of second portions 1311a2 can include one or more of an epoxy-based polymer, an acrylic-based polymer, and a silicone-based polymer, but embodiments of the present disclosure are not limited thereto. For example, each of the plurality of second portions 1311a2 can be an organic portion, an organic material portion, an adhesive portion, a stretch portion, a bending portion, a damping portion, or a ductile portion, but embodiments of the present disclosure are not limited thereto.

A first surface of each of the plurality of first portions 1311a1 and the plurality of second portions 1311a2 can be connected to the first electrode portion 1311b in common. A second surface of each of the plurality of first portions 1311a1 and the plurality of second portions 1311a2 can be connected to the second electrode portion 1311c in common.

The plurality of first portions 1311a1 and the plurality of second portion 1311a2 can be disposed on (or connected to) the same plane, and thus, the vibration portion 1311a according to another embodiment of the present disclosure can have a single thin film-type. Accordingly, the vibration generating part 1311 or the vibration generator 1310 including the vibration portion 1311a according to another embodiment of the present disclosure can vibrate by the first portion 1311a1 having a vibration characteristic and can be bent in a curved shape by the second portion 1311a2 having flexibility.

FIG. 11 is a diagram illustrating a vibration portion according to another aspect of the present disclosure. FIG. 11 illustrates another embodiment of the vibration portion described above with reference to FIGS. 7 to 9.

Referring to FIGS. 8 and 11, the vibration portion 1311a according to another embodiment of the present disclosure can include a plurality of first portions 1311a3 and a second portion 1311a4 disposed between the plurality of first portions 1311a3.

Each of the plurality of first portions 1311a3 can be disposed to be spaced apart from one another along each of the first direction X and the second direction Y. For example, each of the plurality of first portions 1311a3 can have a hexahedral shape having a same size and can be disposed in a lattice shape, but embodiments of the present disclosure are not limited thereto. For example, each of the plurality of first portions 1311a3 can have a circular shape plate, an oval shape plate, or a polygonal shape plate, which has a same size as each other, but embodiments of the present disclosure are not limited thereto.

Each of the plurality of first portions 1311a3 can include a material which is be substantially a same as the first portion 1311a1 described above with reference to FIG. 10, and thus, repeated descriptions thereof are omitted.

The second portion 1311a4 can be disposed between the plurality of first portions 1311a3 along each of the first direction X and the second direction Y. The second portion 1311a4 can be configured to fill a gap between two adjacent first portions 1311a3 or to surround each of the plurality of first portions 1311a3, and thus, the second portion 1311a4 can be connected to or attached on the first portion 1311a3 adjacent thereto. The second portion 1311a4 can include a material which is be substantially a same as the second portion 1311a2 described above with reference to FIG. 10, and thus, repeated descriptions thereof are omitted.

A first surface of each of the plurality of first portions 1311a3 and the second portion 1311a4 can be connected to the first electrode portion 1311b in common. A second surface of each of the plurality of first portions 1311a3 and the second portion 1311a4 can be connected to the second electrode portion 1311c in common.

The plurality of first portions 1311a3 and the second portion 1311a4 can be disposed on (or connected to) the same plane, and thus, the vibration portion 1311a according to another embodiment of the present disclosure can have a single thin film-type. Accordingly, the vibration generating part 1311 or the vibration generator 1310 including the vibration portion 1311a according to another embodiment of the present disclosure can vibrate by the first portion 1311a3 having a vibration characteristic and can be bent in a curved shape by the second portion 1311a4 having flexibility.

FIG. 12 is a diagram illustrating a vibration apparatus according to another aspect of the present disclosure. FIG. 12 illustrates a vibration apparatus including one or more vibration generators described above with reference to FIG. 5.

Referring to FIGS. 5 and 12, the vibration apparatus 333 and 335 according to another embodiment of the present disclosure can include two or more vibration generators 333A, 333B, 335A, and 335B. For example, the vibration apparatus 333 and 335 can include a first vibration generator 333A and 335A and a second vibration generator 333B and 335B.

The first vibration generator 333A and 335A and the second vibration generator 333B and 335B can overlap or be stacked with each other to be displaced (or driven or vibrated) in a same direction to maximize an amplitude displacement of the vibration apparatus 333 and 335 or an amplitude displacement of a vibration member 331. For example, the first vibration generator 333A and 335A and the second vibration generator 333B and 335B can have substantially a same size, but embodiments of the present disclosure are not limited thereto. For example, the first vibration generator 333A and 335A and the second vibration generator 333B and 335B can have substantially a same size within an error range of a manufacturing process, but embodiments of the present disclosure are not limited thereto. Therefore, the first vibration generator 333A and 335A and the second vibration generator 333B and 335B can maximize the amplitude displacement of the vibration apparatus 333 and 335 and/or the amplitude displacement of the vibration member 331.

According to an embodiment of the present disclosure, any one of the first vibration generator 333A and 335A and the second vibration generator 333B and 335B can be connected or coupled to the vibration member 331 by an adhesive member 332 and 334 illustrated in FIG. 3. For example, the first vibration generator 333A and 335A can be connected or coupled to the vibration member 331 by the adhesive member 332 and 334.

Each of the first vibration generator 333A and 335A and the second vibration generator 333B and 335B can include a vibration generating part a same as or substantially a same as the vibration generating part 1311 described above with reference to FIGS. 10 and 11, and thus, like reference numeral refer to like element and repeated descriptions thereof are omitted or can be briefly discussed.

The vibration apparatus 333 and 335 according to another embodiment of the present disclosure can further include an intermediate member 333M and 335M.

The intermediate member 333M and 335M can be disposed or connected between the first vibration generator 333A and 335A and the second vibration generator 333B and 335B. For example, the intermediate member 333M and 335M can be disposed or connected between the second cover member 1315 of the first vibration generator 333A and 335A and the first cover member 1313 of the second vibration generator 333B and 335B. For example, the intermediate member 333M and 335M can be an adhesive member or a connection member, but embodiments of the present disclosure are not limited thereto.

The intermediate member 333M and 335M according to an embodiment of the present disclosure can be configured in a material including an adhesive layer which is good in adhesive force or attaching force with respect to each of the first vibration generator 333A and 335A and the second vibration generator 333B and 335B. For example, the intermediate member 333M and 335M can include a foam pad, a double-sided tape, a double-sided foam tape, a double-sided foam pad, or an adhesive, or the like, but embodiments of the present disclosure are not limited thereto. For example, an adhesive layer of the intermediate member 333M and 335M can include epoxy, acrylic, silicone, or urethane, but embodiments of the present disclosure are not limited thereto. For example, the adhesive layer of the intermediate member 333M and 335M can include a urethane-based material (or substance) having relatively ductile characteristic. Accordingly, the vibration loss caused by displacement interference between the first vibration generator 333A and 335A and the second vibration generator 333B and 335B can be reduced or minimized, or each of the first vibration generator 333A and 335A and the second vibration generator 333B and 335B can be freely displaced (or vibrated or driven).

The vibration apparatus 333 and 335 according to another embodiment of the present disclosure can include the first vibration generator 333A and 335A and the second vibration generator 333B and 335B which are stacked (or piled or overlap) to vibrate (or displace or drive) in the same direction, and thus, the amount of displacement or an amplitude displacement can be maximized or increase. Accordingly, the amount of displacement (or a bending force or a driving force) or an amplitude of displacement of the vibration member 331 can be maximized or increased.

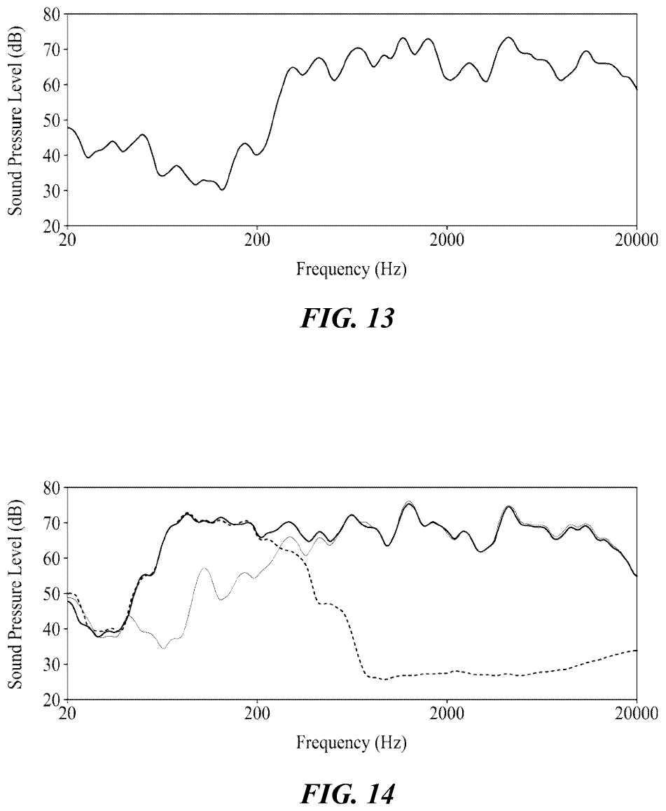

FIG. 13 is a graph illustrating sound pressure characteristics for each frequency of the sound output module according to the aspect of the present disclosure.

In order to measure the sound pressure characteristics for each frequency of the sound output module according to the aspect of the present disclosure, the inventors of the present disclosure manufacture a sample which is the same as the sound output module shown in FIG. 3 and measures the sound pressure characteristics. An audio channel of a measurement equipment is set to 1.1 channel, and a measurement frequency range is set to 50 Hz to 20 KHz. A measurement power (power) is set to 10 W (watt) in the sound output module and set to 10 W in the low-pitched sound generating module, and a total power is set to 20 W. A sound measurement method is not limited to the contents of the present disclosure. In FIG. 13, a horizontal axis represents a frequency (hertz, Hz), and a vertical axis represents a sound pressure level SPL (decibel, dB).

Referring to FIG. 13, in the sound pressure of the sound output module according to the aspect of the present disclosure, a sound pressure in a range of 30 dB to 50 dB is shown in a low-pitched sound range of 50 Hz to 200 Hz (excluding 200 Hz), a sound pressure is rapidly increased at 200 Hz or more, and a sound pressure in a range of 60 dB to 70 dB is shown in a middle/high pitched sound range of 200 Hz or more. Accordingly, the sound output module according to the aspect of the present disclosure has improved the sound characteristics and sound quality characteristics in the sound of the middle/high pitched sound range of about 200 Hz or more.

FIG. 14 is a graph illustrating sound pressure characteristics for each frequency of the apparatus according to the aspect of the present disclosure.

In order to measure the sound pressure characteristic for each frequency of the apparatus according to the aspect of the present disclosure, the inventors of the present disclosure manufacture a sample which is the same as the apparatus shown in FIG. 3 and measures the sound pressure characteristics. In FIG. 14, a thin solid line indicates the sound pressure characteristic of the sound output module and the lighting module. A dotted line indicates the sound pressure characteristic of the low-pitched sound generating module. A thick solid line indicates the sound pressure characteristic of the apparatus including all of the sound output module, the lighting module, and the low-pitched sound generating module. In FIG. 14, a horizontal axis represents a frequency (hertz, Hz), and a vertical axis represents a sound pressure level SPL (decibel, dB).

Referring to FIG. 14, the sound output module and the lighting module according to the aspect of the present disclosure show a sound pressure ranging from 30 dB to 55 dB at a low-pitched sound range of 50 Hz to 200 Hz (excluding 200 Hz), and show a sound pressure ranging from 60 dB to 75 dB at a high-pitched sound range of 200 Hz to 20 KHz. In the low-pitched sound generating module according to the aspect of the present disclosure, a sound pressure in a range from 38 dB to 73 dB is shown in a low-pitched sound range of 50 Hz to 200 Hz (excluding 200 Hz), a sound pressure is gradually decreased at 200 Hz or more, and a sound pressure in a range from 60 dB to 75 dB is shown in a middle/high pitched sound range of 200 Hz to 20 kHz. The apparatus including the sound output module, the lighting module, and the low-pitched sound generating module according to the aspect of the present disclosure shows a sound pressure ranging from 38 dB to 73 dB at a low-pitched sound range of 50 Hz to 200 Hz (excluding 200 Hz), and show a sound pressure ranging from 60 dB to 75 dB at a high-pitched sound range of 200 Hz to 20 KHz.

According to the aspect of the present disclosure, the sound output module and the lighting module are combined with a low-pitched sound generating module (or woofer) capable of reproducing sound at 50 Hz so that it is possible to generate a sound pressure of about 70 dB in a sound range of 50 Hz to 2000 Hz.

Accordingly, the apparatus according to the aspect of the present disclosure may include the sound output module, the lighting module, and the low-pitched sound generating module so that it is possible to improve the sound characteristics and/or sound pressure characteristics of sound including the low-pitched sound range and the high-pitched sound range.

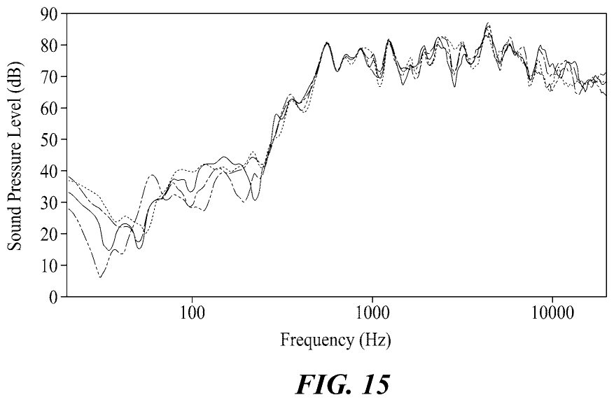

FIG. 15 is a graph illustrating sound pressure characteristics according to a sound pressure measurement angle of the apparatus according to the aspect of the present disclosure.

In order to measure the sound pressure characteristics for each frequency according to the measurement angle of the aspect of the present disclosure, the inventors of the present disclosure manufacture a sample which is the same as the apparatus shown in FIGS. 1 to 3. The sound pressure characteristics may be measured at 0°, 90°, 180°, and 270° positions of the apparatus, respectively. For example, a microphone is positioned at a point of 0.5 m away from each position, and then the sound pressure characteristic according to the frequency is measured. In FIG. 15, a thin solid line, a dotted line, a one-point chain line, and a two-point chain line indicate the sound pressure characteristics at positions of 0°, 90°, 180°, and 270°, respectively. In FIG. 15, a horizontal axis represents a frequency (hertz, Hz), and a vertical axis represents a sound pressure level SPL (decibel, dB).

Referring to FIG. 15, the sound pressure characteristics according to the frequency in the respective positions of 0°, 90°, 180°, and 270° at a frequency less than 200 Hz are different from each other, but the difference between the measured values is not large. In addition, the sound characteristics according to the frequency in the respective positions of 0°, 90°, 180°, and 270° at 200 Hz or more are almost similar.

Accordingly, the apparatus according to the aspect of the present disclosure exhibits similar sound characteristics in all directions. Accordingly, it may be seen that the omni-directional characteristic of 360° appears in the horizontal direction. For example, the omni-directional characteristic may mean that sound or sound waves are uniformly distributed without directionality in a specific direction.

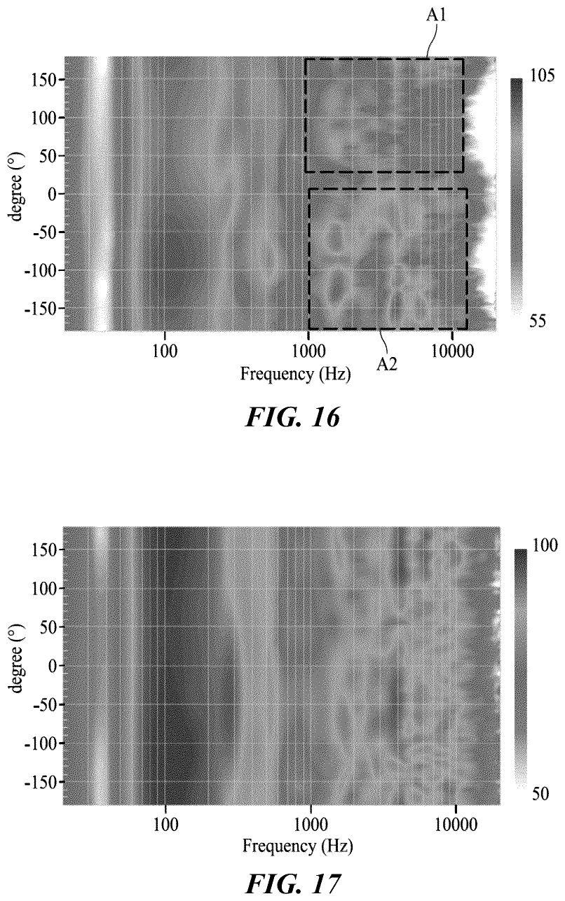

FIG. 16 is a diagram illustrating a sound component distribution in the vertical direction of the apparatus according to the aspect of the present disclosure.

To examine the sound component distribution in the vertical direction according to the aspect of the present disclosure, the inventors of the present disclosure manufacture a sample which is the same as the apparatus shown in FIG. 1 to FIG. 3. In FIG. 16, the sound pressure characteristic is measured when the apparatus is viewed from the front. The portion of 0° is near the left of the light diffusion member, the portion of 90° is the upper portion of the apparatus or is view from the top to the bottom, and the portion of 180° is near the right of the light diffusion member, and the portion of 270° is measured near the lowermost portion adjacent to the bottom surface of the apparatus. For example, the vertical direction may be defined as a vertical direction when the apparatus is viewed from the front. For example, a microphone is positioned at a point of 0.5 m away from each position, and then the sound pressure characteristic according to the frequency is measured as a measurement voltage of IV. In FIG. 16, a horizontal axis represents a frequency (hertz, Hz), and a vertical axis represents a degree. On the right side of FIG. 16, the sound pressure becomes high toward the red, and the highest sound pressure is 105 dB. Also, the sound pressure in the yellow portion is in a range of 91 dB to 94 dB, and the blue portion indicates the sound pressure in a range of 64 dB to 70 dB. The sound pressure becomes lower toward the white, and the lowest sound pressure is measured to be 55 dB. The sound pressure range on the right side of FIG. 16 is illustrated as an example, and the present disclosure is not limited thereto. The left side of FIG. 16 shows an angle, which is indicated in units of 50°. An upper part of 0° represents an angle of 0° to 180°, and a lower part of 0° represents an angle of 0° to −180°. For example, the angle of 0° to −180° may be 0°, −90° (or) 270°, or −180° (or 180°).

Referring to FIG. 16, in the case of the sound component distribution for each frequency in the vertical direction, the sound distribution of middle/high-pitched sound band is large in a region A1 on which the lighting is applied. For example, the region A1 on the lighting is applied may be near 0° and 180° where the lighting module and the light diffusion member are located. For example, in the case of the sound component distribution for each frequency in the vertical direction, the sound distribution of middle/high-pitched sound band is significantly reduced in a region A2 where the lighting is not applied. For example, the region A2 on which the lighting is not applied may be near 90° corresponding to the upper part of the apparatus. For example, the aspects of the present disclosure may be designed such that less sound components are distributed in the range where the lighting is not applied. For example, the upper and lower red portions around 100 Hz are the sound components caused by the low-pitched sound generating module, whereby they may not be affected by the angle.

Accordingly, the apparatus according to the aspect of the present disclosure has an effect of increasing the distribution of sound components by setting the range on which the lighting is applied.

FIG. 17 is a diagram illustrating a sound component distribution in the horizontal direction of the apparatus according to the aspect of the present disclosure.

The inventors of the present disclosure manufacture a sample which is the same as the apparatus shown in FIG. 1 to FIG. 3. In FIG. 17, the sound component is measured when the apparatus is viewed from the front. The sound component is measured at the position where it is at 0°, 90°, 180°, and 270° being horizontal from the center of the circular enclosure. For example, a microphone is positioned at a point of 0.5 m away from each position, and then the sound pressure characteristic according to the frequency is measured. In FIG. 17, a horizontal axis represents a frequency (hertz, Hz), and a vertical axis represents a degree. On the right side of FIG. 17, the sound pressure becomes high toward the red, and the highest sound pressure is 100 dB. Also, the sound pressure in the yellow portion is in a range of 86 dB to 89 dB, and the blue portion indicates the sound pressure in a range of 59 dB to 65 dB. The sound pressure becomes lower toward the white, and the lowest sound pressure is measured to be 50 dB. The sound pressure range on the right side of FIG. 17 is illustrated as an example, and the present disclosure is not limited thereto. The left side of FIG. 17 shows an angle, which is indicated in units of 50°. An upper part of 0° represents an angle of 0° to 180°, and a lower part of 0° represents an angle of 0° to −180°. For example, the angle of 0° to −180° may be 0°, −90° (or) 270°, or −180° (or 180°).

Referring to FIG. 17, the sound component distribution for each frequency is similarly measured regardless of the angle. For example, the sound component distribution in the respective positions of 0°, 90°, 180°, and 270° at a high band of 1000 Hz or more are almost similarly red, and the sound component distribution in each position is similar. For example, the upper and lower red and thick portions around 100 Hz are the sound components caused by the low-pitched sound generating module, whereby they may not be affected by the angle.

Accordingly, the apparatus according to the aspect of the present disclosure shows similar sound component distributions in all directions being horizontal from the apparatus, and thus the sound (or sound wave) is distributed in various directions. Accordingly, the apparatus according to the aspect of the present disclosure exhibits the omnidirectional characteristic of 360° in the horizontal direction.

According to the aspect of the present disclosure, the sound apparatus may output sound in various directions, and the structure may be simplified.

According to the aspect of the present disclosure, the sound apparatus may output sound in various directions by using one sound output module, thereby reducing volume and weight and implementing the light sound apparatus.

A sound apparatus according to example embodiments of the present disclosure are described below.

A sound apparatus according to one or more embodiments of the present disclosure can comprise a sound output module having an opening portion, a support structure provided in the sound output module, and a guide member provided in the support structure and disposed below the opening portion.

According to one or more embodiments of the present disclosure, the guide member can include a bottom portion having a size larger than that of the opening portion, a top portion overlapping the center of the opening portion, and an inclined portion inclined between the top portion and the bottom portion.

According to one or more embodiments of the present disclosure, the bottom portion can have a circular shape, and the inclined portion can have a curved shape.

According to one or more embodiments of the present disclosure, the support structure can include a plurality of support portions for supporting the guide member, and the guide member can be disposed between the plurality of support portions while being overlapped with the opening portion.

According to one or more embodiments of the present disclosure, the sound output module can include a sound generating module, and an enclosure provided in the sound generating module and configured to have the opening portion. The support structure can be configured on a rear surface of the enclosure.

According to one or more embodiments of the present disclosure, the sound apparatus can further comprise a lighting module provided under the guide member.

According to one or more embodiments of the present disclosure, the guide member can include a bottom portion having a size larger than that of the opening portion, a top portion overlapping the center of the opening portion, and an inclined portion inclined between the top portion and the bottom portion. The lighting module can be configured to output light to the top portion and the inclined portion of the guide member.

According to one or more embodiments of the present disclosure, the sound apparatus can further comprise a reflective layer provided on a rear surface of the sound output module facing the guide member.

According to one or more embodiments of the present disclosure, the sound apparatus can further comprise a low-pitched sound generating module provided in the support structure.

According to one or more embodiments of the present disclosure, the enclosure can have an inner space, and the sound generating module can be configured in the inner space.

According to one or more embodiments of the present disclosure, a length of the opening portion can be 50% or less of a length of the enclosure.

According to one or more embodiments of the present disclosure, the sound generating module can include a vibration member configured in the inner space and provided spaced apart from the opening portion, and a vibration apparatus configured in the vibration member.

According to one or more embodiments of the present disclosure, a distance between the guide member and the center of the vibration member is 55 mm or less.

According to one or more embodiments of the present disclosure, the vibration apparatus can include a first vibration apparatus configured on a first surface of the vibration member, and a second vibration apparatus configured on a second surface which is different from the first surface of the vibration member.

According to one or more embodiments of the present disclosure, the vibration member can comprise a metallic material or comprise a single non-metallic or composite non-metallic material of one or more of wood, rubber, plastic, carbon, glass, fiber, cloth, paper, mirror, and leather.

According to one or more embodiments of the present disclosure, the enclosure can include a first enclosure having the opening portion, and a second enclosure connected with the first enclosure. The sound generating module can be configured in an inner space between the first enclosure and the second enclosure.

According to one or more embodiments of the present disclosure, the inner space can include a first space between a first surface of the sound generating module and the first enclosure and connected to the opening portion, and a second space between a second surface opposite the first surface of the sound generation module and the second enclosure.

According to one or more embodiments of the present disclosure, the sound generating module can include a vibration member disposed in the inner space and supported by the first enclosure and the second enclosure, a first vibration apparatus connected to the first surface of the vibration member, and a second vibration apparatus connected to the second surface different from the first surface of the vibration member or connected to the first vibration apparatus.

According to one or more embodiments of the present disclosure, the first enclosure can include an inner surface facing the vibration member and an outer surface opposite to the inner surface, and the enclosure can further include a protrusion protruding from the outer surface of the first enclosure to enclose the opening portion.

According to one or more embodiments of the present disclosure, the vibration apparatus can include one or more vibration generators. The one or more vibration generators can include a vibration portion, a first electrode portion on a first surface of the vibration portion, and a second electrode portion on a second surface different from the first surface of the vibration portion.

According to one or more embodiments of the present disclosure, the vibration portion can include a piezoelectric material.

According to one or more embodiments of the present disclosure, the vibration portion can include a plurality of inorganic material portions having piezoelectric properties, and an organic material portion between the plurality of inorganic material portions.

According to one or more embodiments of the present disclosure, the one or more vibration generators can include a first cover member in the first electrode portion, and a second cover member in the second electrode portion.

According to one or more embodiments of the present disclosure, the one or more vibration generators can further include a signal supply member electrically connected to the vibration portion. A portion of the signal supply member can be received between the first cover member and the second cover member.

According to one or more embodiments of the present disclosure, the vibration apparatus can include a first vibration generator and a second vibration generator stacked on each other. Each of the first vibration generator and the second vibration generator can include a vibration portion, a first electrode portion on a first surface of the vibration portion, and a second electrode portion on a second surface different from the first surface of the vibration portion.

According to one or more embodiments of the present disclosure, the vibration apparatus can further include an intermediate member connected between the first vibration generator and the second vibration generator, and the first vibration generator and the second vibration generator can be displaced in the same direction.

A sound apparatus according to one or more example embodiments of the present disclosure can be applied to or included in a vibration generating apparatus and/or a sound generating apparatus provided in an apparatus. The vibration apparatus and apparatus comprising the same according to one or more example embodiments of the present disclosure can be applied to or included in mobile apparatuses, video phones, smart watches, watch phones, wearable apparatuses, foldable apparatuses, rollable apparatuses, bendable apparatuses, flexible apparatuses, curved apparatuses, sliding apparatuses, variable apparatuses, electronic organizers, electronic books, portable multimedia players (PMPs), personal digital assistants (PDAs), MP3 players, mobile medical devices, desktop personal computers (PCs), laptop PCs, netbook computers, workstations, navigation apparatuses, automotive navigation apparatuses, automotive display apparatuses, automotive apparatuses, theatre apparatuses, theatre display apparatuses, TVs, wall paper display apparatuses, signage apparatuses, game machines, notebook computers, monitors, cameras, camcorders, and home appliances, or the like. In addition, the sound apparatus according to some example embodiments of the present disclosure can be applied to or included in organic light-emitting lighting apparatuses or inorganic light-emitting lighting apparatuses. When the sound apparatus of one or more example embodiments of the present disclosure is applied to or included in lighting apparatuses, the sound apparatus can act as a lighting device and a speaker. In addition, when the sound apparatus according to some example embodiments of the present disclosure is applied to or included in a mobile device, or the like, the sound apparatus can be one or more of a speaker, a receiver, and a haptic device, but embodiments of the present disclosure are not limited thereto.

It will be apparent to those skilled in the art that various modifications and variations can be made in the present disclosure without departing from the scope of the disclosures. Thus, it is intended that the present disclosure covers the modifications and variations of this disclosure provided that within the scope of the claims and their equivalents.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A sound apparatus comprising:
a sound output structure;
an opening portion in the sound output structure;
a support structure adjacent to the sound output structure; and
a guide member adjacent to the opening portion.

2. The sound apparatus according to claim 1, wherein the guide member includes:
a bottom portion having a size larger than that of the opening portion;
a top portion overlapping the center of the opening portion; and
an inclined portion continuously and contiguously extends between the top portion and the bottom portion.

3. The sound apparatus according to claim 2,
wherein the bottom portion has a circular shape, and
wherein the inclined portion has a curved shape.

4. The sound apparatus according to claim 2,
wherein the support structure includes a plurality of support portions for supporting the guide member, and
wherein the guide member is disposed between the plurality of support portions while being overlapped with the opening portion from a plan view.

5. The sound apparatus according to claim 1,
wherein the sound output structure includes:
a sound generating structure; and
an enclosure provided in the sound generating structure and configured to have the opening portion, the enclosure having a rear surface,
wherein the support structure is configured on the rear surface of the enclosure.

6. The sound apparatus according to claim 5, further comprising a lighting structure provided adjacent to the guide member.

7. The sound apparatus according to claim 6,
wherein the guide member includes:
a bottom portion having a size larger than that of the opening portion;
a top portion overlapping the center of the opening portion; and
an inclined portion continuously and contiguously extending between the top portion and the bottom portion,
wherein the lighting module is configured to output light to the top portion and the inclined portion of the guide member.

8. The sound apparatus according to claim 1, further comprising a reflective layer provided on a rear surface of the sound output structure facing the guide member.

9. The sound apparatus according to claim 1, further comprising a low-pitched sound generating structure provided in the support structure.

10. The sound apparatus according to claim 5,
wherein the enclosure has an inner space, and
wherein the sound generating structure is configured in the inner space.

11. The sound apparatus according to claim 5, wherein a length of the opening portion is 50% or less of a length of the enclosure.

12. The sound apparatus according to claim 10,
wherein the sound generating structure includes:
a vibration member configured in the inner space and provided spaced apart from the opening portion; and
a vibration apparatus configured in the vibration member.

13. The sound apparatus according to claim 12, wherein a distance between the guide member and the center of the vibration member is 55 mm or less.

14. The sound apparatus according to claim 12,
wherein the vibration apparatus includes:
a first vibration apparatus configured on a first surface of the vibration member; and
a second vibration apparatus configured on a second surface which is different from the first surface of the vibration member.

15. The sound apparatus according to claim 12, wherein the vibration member comprises a metallic material or comprises a single non-metallic or composite non-metallic material of one or more of wood, rubber, plastic, carbon, glass, fiber, cloth, paper, mirror, and leather.

16. The sound apparatus according to claim 5,
wherein the enclosure includes:
a first enclosure having the opening portion; and
a second enclosure connected with the first enclosure,
wherein the sound generating structure is configured in an inner space between the first enclosure and the second enclosure.

17. The sound apparatus according to claim 16,
wherein the inner space includes:
a first space between a first surface of the sound generating structure and the first enclosure and connected to the opening portion; and
a second space between a second surface opposite the first surface of the sound generation structure and the second enclosure.

18. The sound apparatus according to claim 16,
wherein the sound generating structure includes:
a vibration member disposed in the inner space and supported by the first enclosure and the second enclosure;
a first vibration apparatus connected to the first surface of the vibration member; and
a second vibration apparatus connected to the second surface different from the first surface of the vibration member or connected to the first vibration apparatus.

19. The sound apparatus according to claim 18,
wherein the first enclosure includes an inner surface facing the vibration member and an outer surface opposite to the inner surface, and
the enclosure further includes a protrusion protruding from the outer surface of the first enclosure to enclose the opening portion.

20. The sound apparatus according to claim 1,
wherein the vibration apparatus includes one or more vibration generators,
wherein the one or more vibration generators include:
a vibration portion;
a first electrode portion on a first surface of the vibration portion; and
a second electrode portion on a second surface different from the first surface of the vibration portion.

21. The sound apparatus according to claim 20, wherein the vibration portion includes a piezoelectric material.

22. The sound apparatus according to claim 20,
wherein the vibration portion includes:
a plurality of inorganic material portions having piezoelectric properties; and
an organic material portion between the plurality of inorganic material portions.

23. The sound apparatus according to claim 20,
wherein the one or more vibration generators include:
a first cover member in the first electrode portion; and
a second cover member in the second electrode portion.

24. The sound apparatus according to claim 23,
wherein the one or more vibration generators further include a signal supply member electrically connected to the vibration portion,
wherein a portion of the signal supply member is received between the first cover member and the second cover member.

25. The sound apparatus according to claim 1,
wherein the vibration apparatus includes a first vibration generator and a second vibration generator stacked on each other,
wherein each of the first vibration generator and the second vibration generator includes:
a vibration portion;
a first electrode portion on a first surface of the vibration portion; and
a second electrode portion on a second surface different from the first surface of the vibration portion.

26. The sound apparatus according to claim 25,
wherein the vibration apparatus further includes an intermediate member connected between the first vibration generator and the second vibration generator, and
wherein the first vibration generator and the second vibration generator are displaced in the same direction.

27. The sound apparatus according to claim 18, wherein the opening portion has a size smaller than that of the first vibration apparatus.

28. The sound apparatus according to claim 11, wherein a length of the opening portion is smaller than that of the sound generating structure.

29. The sound apparatus according to claim 22, wherein each of the plurality of inorganic material portions and the organic material portion is disposed on a same plane in parallel with each other.

30. The sound apparatus according to claim 22, wherein a first surface of each of the plurality of inorganic material portions and the organic material portion is connected to the first electrode portion in common, and a second surface of each of the plurality of inorganic material portions and the organic material portion is connected to the second electrode portion in common.

31. The sound apparatus according to claim 22, wherein each of the plurality of inorganic material portions is configured as a ceramic-based material or a piezoelectric ceramic having a perovskite-based crystalline structure.

32. The sound apparatus according to claim 26, wherein the intermediate member includes a urethane-based material having ductile characteristic.

33. The sound apparatus according to claim 24, wherein the signal supply member includes a first signal line and a second signal line, and
wherein an end portion of the first signal line is maintained with being electrically connected to the first electrode portion, and an end portion of the second signal line is maintained with being electrically connected to the second electrode portion.

34. The sound apparatus according to claim 33, wherein the signal supply member further includes a base member and an insulation layer disposed at a surface of the base member, and
wherein an end portion of each of the first signal line and the second signal line protrudes to have a certain length from an end of the base member or an end of the insulation layer.

35. A lighting apparatus comprising:
a lighting structure; and
a sound apparatus including:
a sound output structure;
an opening portion in the sound output structure;
a support structure adjacent to the sound output structure; and
a guide member adjacent to the opening portion,
wherein the lighting structure is positioned adjacent to the guide member, and
wherein the lighting module is configured to output light towards the guide member.
